(19) United States
(12) Patent Application Publication
(10) Pub. No.: US 2026/0304331 A1
(43) Pub. Date: Oct. 1, 2026

(54) RADIO FREQUENCY EXPOSURE COMPLIANCE FOR RADIO FREQUENCY IDENTIFICATION COMMUNICATIONS

(71) Applicant: QUALCOMM Incorporated, San Diego, CA (US)

(72) Inventors: Huang LOU, Santee, CA (US); Farhad MESHKATI, San Diego, CA (US); Sheng-Yuan TU, San Diego, CA (US); Jagadish NADAKUDUTI, Bermuda Dunes, CA (US)

(21) Appl. No.: 19/090,759

(22) Filed: Mar. 26, 2025

(51) Int. Cl. H04W 52/36; H04W 52/38

(52) U.S. Cl. CPC H04W 52/367; H04W 52/38

(57) ABSTRACT

Techniques and apparatus for radio frequency (RF) exposure compliance for radio frequency identification (RFID) transmissions are described. An example method that may be performed by a wireless device includes determining an RF exposure budget for at least one first radio associated with an RFID radio access technology (RAT). The RFID RAT is one of multiple RATs that the wireless device is configured to communicate with. Operation of the at least one first radio associated with the RFID RAT is controlled in compliance with an RF exposure limit, based at least in part on the RF exposure budget.

### INTRODUCTION

### Field of the Disclosure

Aspects of the present disclosure relate to wireless communications, and more particularly, to radio frequency (RF) exposure compliance.

### DESCRIPTION OF RELATED ART

Wireless communication systems are widely deployed to provide various telecommunication services such as telephony, video, data, messaging, broadcasts, etc. Modern wireless communication devices (such as cellular telephones) are generally mandated to meet radio frequency (RF) exposure limits set by certain governments and international standards and regulations. To ensure compliance with the standards, such devices currently undergo an extensive certification process prior to being shipped to market. To ensure that a wireless communication device complies with an RF exposure limit, techniques have been developed to enable the wireless communication device to assess RF exposure from the wireless communication device and adjust the transmission power of the wireless communication device accordingly to comply with the RF exposure limit.

### SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description,” one will understand how the features of this disclosure provide advantages that include improved wireless communication performance while complying with radio frequency (RF) exposure limits.

Certain aspects of the subject matter described in this disclosure can be implemented in a method for wireless communication performed by a wireless device. The method generally includes determining a radio frequency (RF) exposure budget for at least one first radio associated with a radio frequency identification (RFID) radio access technology (RAT). The RFID RAT is one of a plurality of RATs that the wireless device is configured to communicate with. The method also includes controlling operation of the at least one first radio associated with the RFID RAT in compliance with an RF exposure limit, based at least in part on the RF exposure budget.

Certain aspects of the subject matter described in this disclosure can be implemented in an apparatus for wireless communication. The apparatus generally includes one or more memories collectively storing executable instructions, and one or more processors coupled to the one or more memories. The one or more processors are collectively configured to execute the executable instructions to cause the apparatus to: determine a radio frequency (RF) exposure budget for at least one first radio associated with a radio frequency identification (RFID) radio access technology (RAT), wherein the RFID RAT is one of a plurality of RATs that the apparatus is configured to communicate with; and control operation of the at least one first radio associated with the RFID RAT in compliance with an RF exposure limit, based at least in part on the RF exposure budget.

Certain aspects of the subject matter described in this disclosure can be implemented in an apparatus for wireless communication. The apparatus generally includes means for determining a radio frequency (RF) exposure budget for at least one first radio associated with a radio frequency identification (RFID) radio access technology (RAT). The RFID RAT is one of a plurality of RATs that the apparatus is configured to communicate with. The apparatus also includes means for controlling operation of the at least one first radio associated with the RFID RAT in compliance with an RF exposure limit, based at least in part on the RF exposure budget.

Other aspects provide: an apparatus operable, configured, or otherwise adapted to perform any one or more of the aforementioned methods and/or those described elsewhere herein; a non-transitory, computer-readable medium comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication system exhibiting radio frequency (RF) exposure to a human, in accordance with certain aspects of the present disclosure.

FIG. 2 is a block diagram conceptually illustrating a design of an example wireless communication device communicating with another device, in accordance with certain aspects of the present disclosure.

FIG. 3 is a graph illustrating examples of transmit powers over time in compliance with an RF exposure limit, in accordance with certain aspects of the present disclosure.

FIG. 4A is a diagram illustrating an example wireless device having multiple radios, in accordance with certain aspects of the present disclosure.

FIG. 4B is a diagram illustrating an example logical architecture for controlling the transmit power associated with one or more radios of a wireless device, in accordance with certain aspects of the present disclosure.

FIG. 5 is a block diagram illustrating an example grouping of multiple antennas of a wireless device, in accordance with certain aspects of the present disclosure.

FIGS. 6A-6C depict various examples of RF exposure compliance for RFID communications, in accordance with certain aspects of the present disclosure.

FIG. 7 is a table illustrating example split ratios for multiple radios/radio access technologies (RATs) across different antenna groups for a transmit scenario, in accordance with certain aspects of the present disclosure.

FIG. 8 is a table illustrating example reserve information for multiple services for multiple antenna groups, in accordance with certain aspects of the present disclosure.

FIG. 9 illustrates a workflow for controlling RF exposure of an RFID radio in compliance with an RF exposure limit, in accordance with certain aspects of the present disclosure.

FIG. 10 is a flow diagram illustrating example operations for wireless communication by a wireless device, in accordance with certain aspects of the present disclosure.

FIG. 11 illustrates a communications device (e.g., a user equipment (UE)) that may include various components configured to perform operations for the techniques disclosed herein, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer-readable mediums for radio frequency (RF) exposure compliance for radio frequency identification (RFID) communications.

RFID generally involves the use of radio waves (e.g., electromagnetic fields) to read information stored on a small chip (commonly referred to as a “tag”). This tag can be attached to, embedded in, or otherwise in close proximity with an object, and may include a unique identifier. In RFID communications, an RFID reader may send and receive signals to read or write data on one or more tags. RFID readers may come in various forms, including standalone devices and wireless devices (e.g., smartphones) with specialized hardware. In some examples, the RFID reader periodically transmits a continuous wave or other signal to charge the tag and enable the tag to receive communications from the RFID reader and respond thereto. RFID technology may be used in a wide variety of applications, including inventory tracking in retail environments, monitoring medical equipment in hospitals, and tracking luggage in airports, as illustrative examples.

In certain cases, a wireless device (e.g., smartphone) may include a radio that supports RFID communications with one or more tags (e.g., an RFID radio access technology (RAT)). Such a device may be referred to as a phone RFID reader. One issue with such devices is that the RFID communications may have an impact on the RF exposure of the device, and therefore may impact the device's compliance with an RF exposure limit.

Accordingly, certain aspects of the present disclosure provide techniques and apparatus for RF exposure compliance for a wireless device that includes one or more radios (implemented on one or more chipsets) that support RFID RATs as well as other types of RATs (e.g., wireless wide area network (WWAN) RATs, wireless local area network (WLAN) RATs, Bluetooth RATs, among others). In an illustrative, non-limiting example, the wireless device may include a radio (or chipset) that supports (i) RFID communications, (ii) a WWAN radio (or chipset) that supports WWAN RAT(s) (e.g., Fifth Generation (5G) New Radio (NR), Evolved Universal Terrestrial Radio Access (E-UTRA) (also known as a Fourth Generation (4G) RAT), Universal Mobile Telecommunications System (UMTS) (also known as a Second Generation (2G)/Third Generation (3G) RAT) and/or code division multiple access (CDMA) (also known as a 2G/3G RAT)), (iii) a WLAN radio (or chipset) that supports WLAN RAT(s) (e.g., Institute of Electrical and Electronics Engineers (IEEE) 802.11 (also known as WiFi)), (iv) a Bluetooth radio (or chipset) that supports Bluetooth access technologies, (v) a radio (or chipset) that supports non-terrestrial communications (e.g., satellite communications), (vi) a radio (or chipset) that supports peer-to-peer (P2P) or device-to-device (D2D) communications, (vii) a radio (or chipset) that supports vehicle-to-everything (V2X) communications, or (viii) any combination thereof. Note, a chipset may include one or more types of radios.

In certain cases, a regulatory agency (e.g., the Federal Communications Commission (FCC) for the United States or the Innovation, Science and Economic Development Canada (ISED) for Canada) and/or a standards organization (e.g., the International Commission on Non-Ionizing Radiation Protection (ICNIRP)) may specify a time-averaged RF exposure limit in order to ensure safe levels of RF exposure as further described herein. In such cases, a wireless device may evaluate RF exposure compliance using a time-averaged operation. For example, the wireless device may perform an RF exposure assessment of past RF exposure over a given time window (e.g., time-averaging window) to determine a transmit power (e.g., maximum allowable transmit power) for a future time interval in the time window that is in compliance with the RF exposure limit (e.g., time-averaged RF exposure limit) for a given transmit scenario associated with the wireless device. As discussed further below, a transmit scenario may correspond to various combinations of radios, communication technologies (e.g., RATs), antennas, antenna groupings, antenna configurations (or beams) (e.g., transmit beam configuration), operating conditions, frequency bands, RF exposure scenarios (e.g., head exposure, body-worn exposure, extremity (hand) exposure, and/or hotspot exposure), device use-case scenarios (e.g., based on active applications on the device, such as voice vs. data applications, gaming vs. video-call applications active on the device), and/or geographical locations or regions (e.g., countries or regions), as illustrative, non-limiting examples.

As described in greater detail herein, for transmit scenarios involving a radio that supports an RFID RAT (referred to herein as an RFID radio), certain aspects of the present disclosure may provide apparatus and methods for controlling operation of the RFID radio in compliance with an RF exposure limit (e.g., time-averaged RF exposure limit). For example, in certain aspects, a wireless device may determine an RF exposure budget for the RFID radio that applies for a time window and/or an interval thereof (e.g., future time window including the interval). The wireless device may determine at least one of a transmit power or a transmit duration for the RFID radio that applies during the time window and/or interval, based on the RF exposure budget, and may send RFID communications (e.g., RFID transmissions) during the time window or interval via the RFID radio according to the transmit power and/or transmit duration.

The apparatus and methods for RF exposure compliance for RFID communications as well as other communications described herein may provide various advantages. For example, controlling RF exposure of an RFID radio in compliance with an RF exposure limit may improve the RFID performance of the wireless device in terms of improved (higher) tag detection (or read) rates, improved (higher) tag detection (or read) ranges, increased throughput, and/or reduced latency, as illustrative, non-limiting examples.

As used herein, a radio may refer to a physical or logical transmission path associated with one or more active frequency bands, transceivers, and/or RATs (e.g., RFID, CDMA, Long Term Evolution (LTE), NR, IEEE 802.11, Bluetooth, etc.) used for wireless communications. For example, for uplink carrier aggregation in LTE and/or NR, each of the active component carriers used for wireless communications may be treated as a separate radio. Similarly, multi-band transmissions for IEEE 802.11 communications may be treated as separate radios for each band (e.g., 2.4 gigahertz (GHz), 5 GHZ, or 6 GHZ). As used herein, a “minimum reserve” or merely “reserve” may refer to a minimum level of transmit power allocated to one or more radios for a certain duration (e.g., a transmission occasion, a time window associated with a (time-averaged) RF exposure limit, or a portion thereof).

The following description provides examples of RF exposure compliance, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular RAT and may operate on one or more frequencies. A RAT may also be referred to as a radio technology, an air interface, etc. A frequency may also be referred to as a carrier, a subcarrier, a frequency channel, a channel, a tone, a subband, etc. Each frequency may support a single RAT in a given geographic area in order to avoid interference between wireless networks of different RATs, or may support multiple RATs.

As used herein, a radio may refer to a physical or logical transmission path associated with one or more frequency bands (carriers, channels, bandwidths, subdivisions thereof, etc.), transmitters (or transceivers), and/or RATs (e.g., RFID communications, WWAN, WLAN, short-range communications (e.g., Bluetooth), non-terrestrial communications, D2D communications, V2X communications, etc.) used for wireless communications. For example, for uplink carrier aggregation (or multi-connectivity) in WWAN, each of the active component carriers used for wireless communications may be treated as a separate radio. Similarly, multi-band transmissions for IEEE 802.11 may be treated as separate radios for each frequency band (e.g., 2.4 gigahertz (GHz), 5 GHZ, and/or 6 GHz). In some examples, a radio is defined based on a RAT and/or frequency for the purposes of RF exposure determination and/or RF exposure compliance.

The techniques described herein may be used for various wireless networks and radio technologies. While aspects may be described herein using terminology commonly associated with 3G, 4G, and/or 5G (e.g., 5G NR) wireless technologies, aspects of the present disclosure can be applied in other generation-based communication systems and/or to wireless technologies such as IEEE 802.11, 802.15, etc.

Although the terms “first,” “second,” “third,” etc., may be used herein to describe various devices, elements, components, regions, layers and/or sections, these devices, elements, components, regions, layers and/or sections should not be limited by these terms. These terms may be only used to distinguish one device, element, component, region, layer or section from another device, element, component, region, layer, or section. Terms such as “first,” “second,” and other numerical terms, when used herein, do not imply a sequence or order unless clearly indicated by the context. Thus, a first device, element, component, region, layer, or section discussed herein could be termed a second device, element, component, region, layer, or section without departing from the scope of the present disclosure.

### Example Wireless Communication Network and Devices

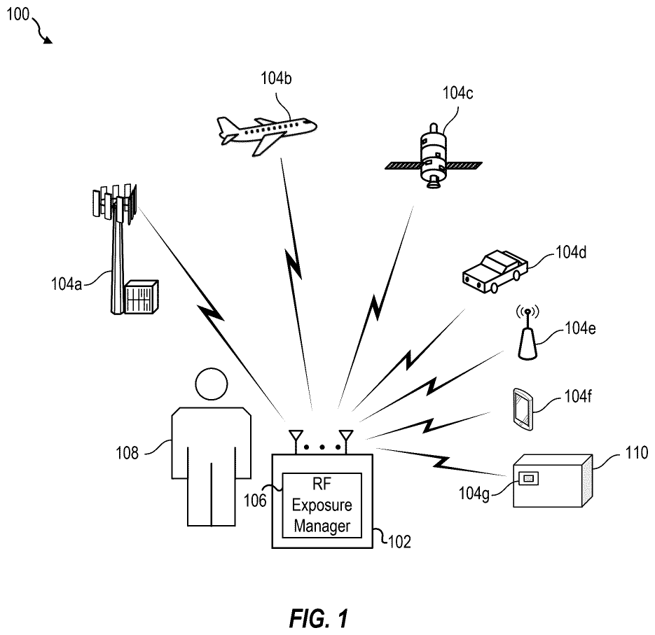

FIG. 1 illustrates an example wireless communication system 100 in which aspects of the present disclosure may be performed. For example, the wireless communication system 100 may include an RFID system, a WWAN, a WLAN, a D2D communications network, a V2X system, a short-range communications system (e.g., Bluetooth communications), or any combination thereof.

As illustrated in FIG. 1, the wireless communication system 100 may include a wireless device 102 communicating with any of various wireless devices 104a-104g (a wireless device 104) via any of various RATs, where a wireless device may refer to a wireless communication device. The RATs may include, for example, RFID communications, WWAN communications (e.g., E-UTRA and/or 5G NR), WLAN communications (e.g., IEEE 802.11), V2X communications, non-terrestrial network (NTN) communications, short-range communications (e.g., Bluetooth), etc.

The wireless device 102 may be emitting RF signals in proximity to a human 108, who may be the user of the wireless device 102 and/or a bystander. As an example, the wireless device 102 may be held in the hand of the human 108 and/or positioned against or near the head of the human 108. In certain cases, the wireless device 102 may be positioned in a pocket or bag of the human 108. In some cases, the wireless device 102 may positioned proximate to the human 108 as a mobile hotspot. To ensure the human 108 is not overexposed to RF emissions from the wireless device 102, the wireless device 102 may control the transmit power and/or transmit duration associated with the RF signals in accordance with an RF exposure limit, as further described herein, where the RF exposure limit may depend on the corresponding exposure scenario (e.g., head exposure, hand (extremity) exposure, body (body-worn) exposure, hotspot exposure, etc.).

The wireless device 102 may include any of various wireless communication devices including a user equipment (UE), a wireless station, an access point, a customer-premises equipment (CPE), etc. In certain aspects, the wireless device 102 includes an RF exposure manager 106 that manages the RF exposure associated with one or more radios in compliance with an RF exposure limit, in accordance with aspects of the present disclosure. For example, the RF exposure manager 106 may determine an RF exposure budget for an RFID radio, and control operation of the RFID radio in compliance with an RF exposure limit, based on the RF exposure budget, as described further herein.

The wireless devices 104a-104g may include, for example, a base station 104a, an aircraft 104b, a satellite 104c, a vehicle 104d, an access point 104e, a UE 104f, and/or a tag 104g. Further, the wireless communication system 100 may include terrestrial aspects, such as ground-based network entities (e.g., the base station 104a and/or access point 104e), and/or non-terrestrial aspects, such as the aircraft 104b and the satellite 104c, which may include network entities on-board (e.g., one or more base stations) capable of communicating with other network elements (e.g., terrestrial base stations) and/or user equipment.

The base station 104a may generally include: a NodeB (NB), enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. The base station 104a may provide communications coverage for a respective geographic coverage area, which may sometimes be referred to as a cell, and which may overlap in some cases (e.g., a small cell may have a coverage area that overlaps the coverage area of a macro cell). A base station may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

The tag 104g is generally representative of an RFID tag, which may include a small chip (e.g., integrated circuit (IC)) and an antenna that uses radio waves to transmit data. The tag 104g may be attached to, embedded in, or otherwise in close proximity with an object 110. The tag 104g may communicate with an RFID reader, such as a phone RFID reader (e.g., the wireless device 102 and/or UE 104f), via RFID communications. The tag 104 may be representative of various types of RFID tags, including passive RFID tags (e.g., tags that do not have their own power source and rely on the reader for energy), active RFID tags (e.g., tags that have their own power source), and semi-passive RFID tags (e.g., tags that have their own power source but rely on the reader's signal to communicate similar to passive RFID tags), as illustrative examples.

The wireless device 102 and/or the UE 104f may generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always-on (AON) devices, edge processing devices, or other similar devices. A UE may also be referred to more generally as a mobile device, a wireless device, a wireless communications device, a station (STA), a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and other terms.

In certain cases, the wireless device 102 may control the transmit power used to emit RF signals in compliance with an RF exposure limit. RF exposure may be expressed in terms of a specific absorption rate (SAR), which measures energy absorption by human tissue per unit mass and may have units of watts per kilogram (W/kg). RF exposure may also be expressed in terms of power density (PD), which measures energy absorption per unit area and may have units of milliwatts per square centimeter (mW/cm²). In certain cases, a maximum permissible exposure (MPE) limit in terms of PD may be imposed for wireless communication devices using transmission frequencies above 6 GHz. Frequency bands of 24 GHz to 71 GHz are sometimes referred to as a “millimeter wave” (“mmW” or “mmWave”). The MPE limit is a regulatory metric for exposure based on area, e.g., an energy density limit defined as a number, X, watts per square meter (W/m2) averaged over a defined area and time-averaged over a frequency-dependent time window in order to prevent a human exposure hazard represented by a tissue temperature change. Certain RF exposure limits may be specified based on a maximum RF exposure metric (e.g., SAR or PD) averaged over a specified time window (e.g., 100 or 360 seconds for sub-6 GHz frequency bands or 2 seconds for 60 GHz bands).

SAR may be used to assess RF exposure for transmission frequencies less than 6 GHz, which cover wireless communication technologies such as RFID, 2G/3G (e.g., CDMA), 4G (e.g., E-UTRA), 5G (e.g., NR in sub-6 GHz bands), IEEE 802.11 (e.g., a/b/g/n/ac), etc. PD may be used to assess RF exposure for transmission frequencies higher than 6 GHz, which cover wireless communication technologies such as IEEE 802.11ad, 802.11ay, 5G in mmWave bands, etc. Thus, different metrics may be used to assess RF exposure for different wireless communication technologies.

A wireless device (e.g., the wireless device 102) may be capable of transmitting signals using multiple wireless communication technologies and/or frequency bands, and in some cases, capable of simultaneous transmission of such signals. For example, the wireless device may transmit signals using a first wireless communication technology operating at or below 6 GHZ (e.g., RFID, 3G, 4G, 5G, 802.11a/b/g/n/ac, etc.) and a second wireless communication technology operating above 6 GHZ (e.g., mmWave 5G in 24 to 60 GHz bands, IEEE 802.11ad or 802.11ay). In certain aspects, the wireless device may transmit signals using the first wireless communication technology (e.g., RFID, 3G, 4G, 5G in sub-6 GHz bands, IEEE 802.11ac, etc.) in which RF exposure may be measured in terms of SAR, and the second wireless communication technology (e.g., 5G in 24 to 71 GHz bands, IEEE 802.11ad, 802.11ay, etc.) in which RF exposure may be measured in terms of PD. As used herein, sub-6 GHz bands may include frequency bands of 300 megahertz (MHz) to 6,000 MHz in some examples, and may include bands in the 6,000 MHz and/or 7,000 MHz range in some examples.

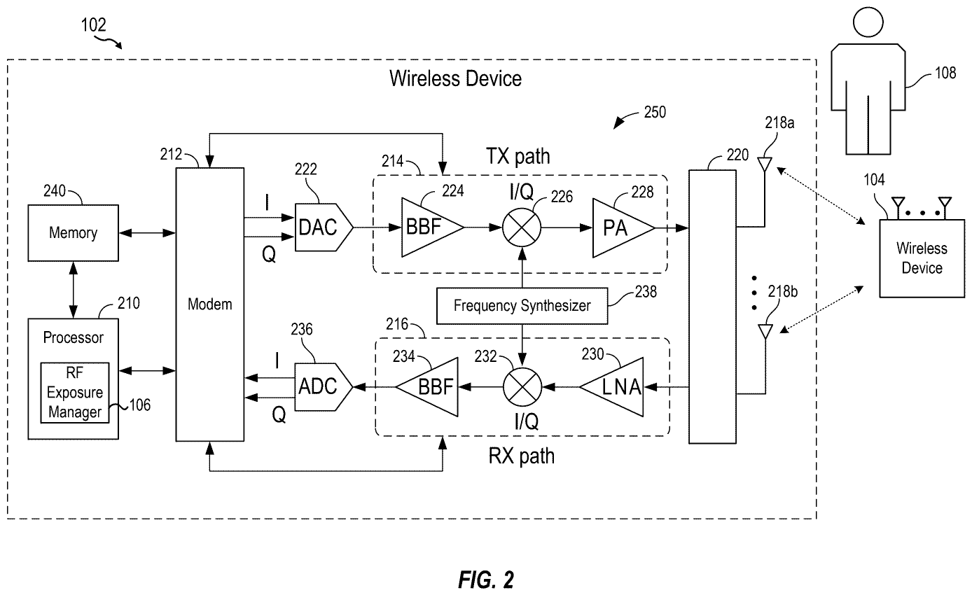

FIG. 2 illustrates example components of the wireless device 102, which may be used to communicate with any of the wireless devices 104, in some cases, in proximity to human tissue as represented by the human 108.

The wireless device 102 may be, or may include, a chip, system on chip (SoC), chipset, package or device that includes one or more modems 212. In some cases, the modem(s) 212 may include, for example, any of an RFID modem (e.g., a modem configured to communicate via RFID), a WWAN modem (e.g., a modem configured to communicate via E-UTRA and/or 5G NR standards), a WLAN modem (e.g., a modem configured to communicate via 802.11 standards), a Bluetooth modem, a NTN modem, etc. In certain aspects, the wireless device 102 also includes one or more radios (collectively “the radio(s) 250”). In some aspects, the wireless device 102 further includes one or more processors, processing blocks, or processing elements (collectively “the processor 210”) and one or more memory blocks or elements (collectively “the memory 240”).

The processor 210 may implement the RF exposure manager 106. In certain aspects, the processor 210 may include a processor that is representative of an application processor that generates information (e.g., application data such as content requests) for transmission and/or receives information (e.g., requested content) via the modem 212. In some cases, the processor 210 may include a microprocessor associated with the modem 212, which may process any of certain protocol stack layers associated with a RAT. For example, the processor 210 may process any of an application layer, packet layer, WLAN protocol stack layers (e.g., a link or MAC layer), and/or WWAN protocol stack layers (e.g., a radio resource control (RRC) layer, a packet data convergence protocol (PDCP) layer, a radio link control (RLC) layer, and a MAC layer). In some cases, at least one of the modems 212 (e.g., the WWAN modem) may be in communication with one or more of the other modems 212 (e.g., the WLAN modem, the RFID modem, and/or the Bluetooth modem). For example, the processor 210 may be representative of at least one of the modems 212 in communication with one or more of the other modems 212.

The modem 212 may include an intelligent hardware block or device such as an application-specific integrated circuit (ASIC), among other possibilities. The modem 212 may generally be configured to implement a physical (PHY) layer. For example, the modem 212 may be configured to modulate packets and to output the modulated packets to the radio(s) 250 for transmission over a wireless medium. The modem 212 is similarly configured to obtain modulated packets received by the radio(s) 250 and to demodulate the packets to provide demodulated packets. In addition to a modulator and a demodulator, the modem 212 may further include digital signal processing (DSP) circuitry, automatic gain control (AGC), a coder, a decoder, a multiplexer, and a demultiplexer (not shown).

As an example, while in a transmission mode, the modem 212 may obtain data from the processor 210. The data obtained from the processor 210 may be provided to a coder, which encodes the data to provide encoded bits. The encoded bits may be mapped to points in a modulation constellation (e.g., using a selected modulation and coding scheme) to provide modulated symbols. The modulated symbols may be mapped, for example, to spatial stream(s) or space-time streams. The modulated symbols may be multiplexed, transformed via an inverse fast Fourier transform (IFFT) block, and subsequently provided to DSP circuitry for transmit windowing and filtering. The digital signals may be provided to a digital-to-analog converter (DAC) 222. In certain aspects involving beamforming, the modulated symbols in the respective spatial streams may be precoded via a steering matrix prior to provision to the IFFT block.

The modem 212 may be coupled to the radio(s) 250 including a transmit (TX) path 214 (also known as a transmit chain) for transmitting signals via one or more antennas 218 and a receive (RX) path 216 (also known as a receive chain) for receiving signals via the antennas 218. When the TX path 214 and the RX path 216 share an antenna 218, the paths may be connected with the antenna via an interface 220, which may include any of various suitable RF devices, such as a switch, a duplexer, a diplexer, a multiplexer, and the like. As an example, the modem 212 may output digital in-phase (I) and/or quadrature (Q) baseband signals representative of the respective symbols to a DAC 222.

Receiving I or Q baseband analog signals from the DAC 222, the TX path 214 may include a baseband filter (BBF) 224, a mixer 226, and a power amplifier (PA) 228. The BBF 224 filters the baseband signals received from the DAC 222, and the mixer 226 mixes the filtered baseband signals with a transmit local oscillator (LO) signal to convert the baseband signal to a different frequency (e.g., upconvert from baseband to a radio frequency). In some aspects, the frequency conversion process produces the sum and difference frequencies between the LO frequency and the frequencies of the baseband signal. The sum and difference frequencies are referred to as the beat frequencies. Some beat frequencies are in the RF range, such that the signals output by the mixer 314 are typically RF signals, which may be amplified by the PA 228 before transmission by the antenna(s) 218. The antenna(s) 218 may emit RF signals, which may be received at the wireless device 104. While one mixer 226 is illustrated, several mixers may be used to upconvert the filtered baseband signals to one or more intermediate frequencies and to thereafter upconvert the intermediate frequency signals to a frequency for transmission.

In some cases, the wireless device 102 may communicate via multiple-input, multiple-output (MIMO) signals. The wireless device 102 may transmit more than one signal via multiple antennas 218a, 218b (collectively “the antennas 218”) to the wireless device 104 through multipath propagation. As an example, a first signal may be transmitted via the first antenna 218a, and a second signal may be transmitted via the second antenna 218b via a different propagation path than the first signal. The MIMO signals may facilitate increased communication link capacity (e.g., throughput) between the wireless device 102 and the wireless device 104.

The RX path 216 may include a low noise amplifier (LNA) 230, a mixer 232, and a baseband filter (BBF) 234. RF signals received via the antenna 218 (e.g., from the wireless device 104) may be amplified by the LNA 230, and the mixer 232 (which may comprise one or several mixers) mixes the amplified RF signals with a receive local oscillator (LO) signal to convert the RF signal to a baseband frequency (e.g., downconvert). The baseband signals output by the mixer 232 may be filtered by the BBF 234 before being converted by an analog-to-digital converter (ADC) 236 to digital I or Q signals for digital signal processing. The modem 212 may receive the digital I or Q signals and further process the digital signals (e.g., demodulating the digital signals).

Certain transceivers may employ frequency synthesizers with a voltage-controlled oscillator (VCO) to generate a stable, tunable LO frequency with a particular tuning range. Thus, the transmit LO frequency may be produced by a frequency synthesizer 238, which may be buffered or amplified by an amplifier (not shown) before being mixed with the baseband signals in the mixer 226. Similarly, the receive LO frequency may be produced by the frequency synthesizer 238, which may be buffered or amplified by an amplifier (not shown) before being mixed with the RF signals in the mixer 232. Separate frequency synthesizers may be used for the TX path 214 and the RX path 216.

While in a reception mode, the modem 212 may obtain digitally converted signals via the ADC 236 and RX path 216. As an example, in the modem 212, digital signals may be provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may be fed to the AGC, which is configured to use information extracted from the digital signals, for example, in one or more received training fields, to determine an appropriate gain. The output of the DSP circuitry also may be coupled with the demodulator, which is configured to extract modulated symbols from the signal and, for example, compute the logarithm likelihood ratios (LLRs) for each bit position of each subcarrier in each spatial stream. The demodulator may be coupled with the decoder, which may be configured to process the LLRs to provide decoded bits. The decoded bits from all of the spatial streams may be fed to the demultiplexer for demultiplexing. The demultiplexed bits may be descrambled and provided to a medium access control layer (e.g., the processor 210) for processing, evaluation, or interpretation.

The processor 210 and/or modem 212 may control the transmission of signals via the TX path 214 and/or reception of signals via the RX path 216. In some aspects, the processor 210 and/or modem 212 may be configured to perform various operations, such as those associated with the methods described herein. The processor 210 and/or the modem 212 may include a microcontroller, a microprocessor, an application processor, a baseband processor, a MAC processor, a neural network processor, a digital signal processor (DSP), an application specific integrated circuit (ASIC), a field programmable gate array (FPGA) or other programmable logic device (PLD), discrete gate or transistor logic, discrete hardware components, or any combination thereof. In some cases, aspects of the processor 210 may be integrated with (incorporated in and/or shared with) the modem 212, such as the RF exposure manager 106, a microcontroller, a microprocessor, a baseband processor, a medium access control (MAC) processor, a digital signal processor, etc. The memory 240 may store data and program codes (e.g., computer-readable instructions) for performing wireless communications as described herein. The memory 240 may be external to the processor 210 and/or the modem 212 (as illustrated) and/or incorporated therein.

In certain cases, the RF exposure manager 106 (as implemented via the processor 210 and/or modem 212) may determine an RF exposure budget for an RFID radio (e.g., radio 250), and control operation of the RFID radio in compliance with an RF exposure limit, based on the RF exposure budget, as described further herein. For example, the RF exposure manager 106 may determine a transmit power (e.g., corresponding to certain levels of gain(s) applied to a TX path(s) 214 including the BBF 224, the mixer 226, and/or the PA 228) and/or a transmit duration for the RFID radio that applies during a time window, based in part on the RF exposure budget.

FIG. 2 shows one reference example of a transceiver design. It will be appreciated that other transceiver designs or architectures may be applied in connection with certain aspects of the present disclosure. For example, while examples discussed herein utilize I and Q signals (e.g., quadrature modulation), those of skill in the art will understand that components of the transceiver may be configured to utilize any other suitable modulation, such as polar modulation. As another example, circuit blocks may be arranged differently from the configuration shown in FIG. 2, and/or other circuit blocks not shown in FIG. 2 may be implemented in addition to or instead of the blocks depicted.

### Example RF Exposure Compliance

In certain cases, compliance with an RF exposure limit may be performed as a time-averaged RF exposure evaluation within a specified running (moving) time window associated with the RF exposure limit. The RF exposure limit may specify a time-averaged RF exposure metric (e.g., SAR and/or PD) over the running time window. As an example, the Federal Communications Commission (FCC) specifies that certain SAR limits (general public exposure) are 0.08 W/kg, as averaged over the whole body, and a peak spatial-average SAR of 1.6 W/kg, averaged over any 1 gram of tissue (defined as a tissue volume in the shape of a cube) for sub-6 GHz bands, whereas certain PD limits are 1 mW/cm², as averaged over the whole body, and a peak spatial-average PD of 4 mW/cm², averaged over any 1 cm². The FCC also specifies the corresponding averaging time may be six minutes (360 seconds) for sub-6 GHz bands, whereas the averaging time may be 2 seconds for mmWave bands (e.g., 60 GHz frequency bands).

The RF exposure limit and/or corresponding averaging time window may vary based on the frequency band. In certain aspects, the RF exposure limit(s) and/or corresponding averaging time window(s), if applicable, may be specific to a particular geographic region or country, such as the United States, Canada, China, or European Union, as illustrative examples. In some cases, the RF exposure limit(s) may specify the maximum allowed RF exposure that can be encountered without time averaging. In such cases, the maximum allowed RF exposure may correspond to a maximum output or transmit power that can be used by the wireless device.

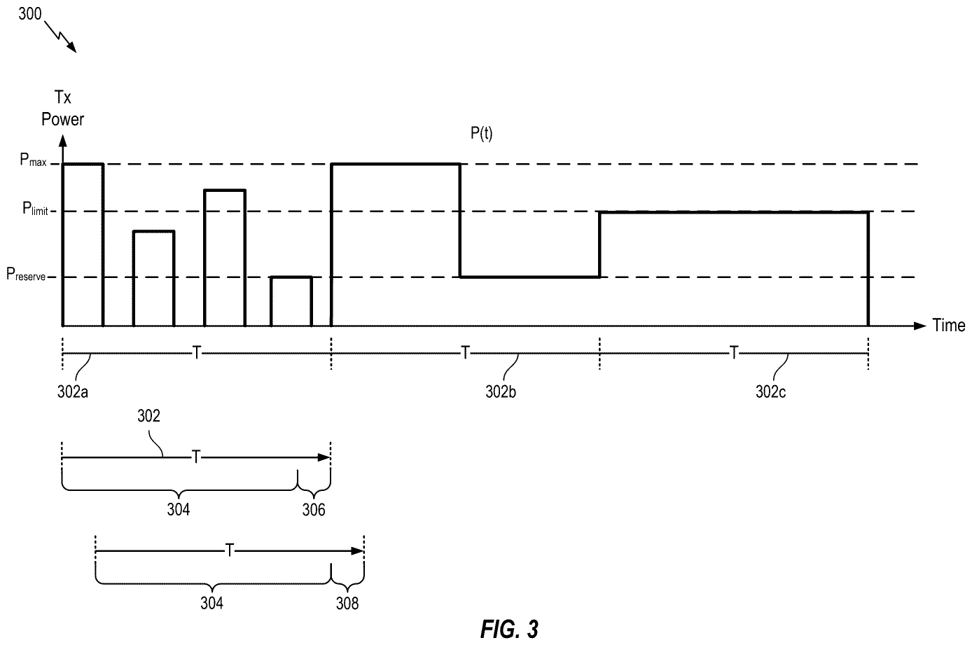

FIG. 3 is a graph 300 of a transmit power over time (P (t)) that varies over a running (e.g., rolling or moving) time window (T) associated with the RF exposure limit. The wireless device (e.g., the wireless device 102) may evaluate RF exposure compliance over the running time window 302 (T) based on past RF exposure (e.g., a transmit power report) in a past time interval 304 of the time window 302 and a future time interval 306. The wireless device may determine the maximum allowed transmit power for the future time interval 306 that satisfies the time-averaged RF exposure limit based on the past RF exposure used in the past time interval 304. The wireless device may perform such a time-averaging evaluation as the time window 302 moves over time, such as in the next future time interval 308, where the past time interval 304 now includes the previous future time interval 306.

The maximum time-averaged transmit power limit (Pₗᵢₘᵢₜ) represents the maximum transmit power the wireless device can transmit continuously for the duration of the running time window 302 (T) in compliance with the RF exposure limit. For example, the wireless device is transmitting continuously at Pₗᵢₘᵢₜ in the time window 302c such that the time-averaged transmit power over the time window (e.g., the time window 302c) is equal to Pₗᵢₘᵢₜ in compliance with the time-averaged RF exposure limit. The RF exposure level corresponding to time-averaged transmit power limit (Pₗᵢₘᵢₜ) may be referred to as an RF exposure design target. The RF exposure design target may be less than or equal to the RF exposure limit. The RF exposure design target may be selected to be less than the RF exposure limit to account for device uncertainty and/or to meet the RF exposure limit in exposure scenarios when transmitting simultaneously with other radios within the same device that have a different RF exposure controlling mechanism.

In certain cases, an instantaneous transmit power may exceed Pₗᵢₘᵢₜ in certain transmission occasions, for example, as shown in the time window 302a and the time window 302b. In some cases, the wireless device may transmit at Pmax, which may be the maximum instantaneous transmit power supported by the wireless device, the maximum instantaneous transmit power the wireless device is capable of outputting, or the maximum instantaneous transmit power allowed by a standard or regulatory body (e.g., the maximum output power, PCMAX). In some cases, the wireless device may transmit at a transmit power less than or equal to Pₗᵢₘᵢₜ in certain transmission occasions, for example, as shown in the time window 302a.

In certain cases, a reserve power may be used to enable a continuous transmission within a time window (T) when transmitting above Pₗᵢₘᵢₜ in the time window or to enable a certain level of quality for certain transmissions. As shown in the time window 302b, the transmit power may be backed off from Pmax to a reserve power (Preserve) so that the wireless device can maintain a continuous transmission during the time window (e.g., maintain a radio connection with a receiving entity) in compliance with the time-averaged RF exposure limit. In the time window 302c, the wireless device may increase the transmit power to Pₗᵢₘᵢₜ in compliance with the time-averaged RF exposure limit. In some cases, Preserve may allow for a certain level of transmission quality for certain transmissions (e.g., control signaling). Preserve may be used to reserve transmit power for at least a portion of the time window 302 for certain transmissions (e.g., control signaling). Preserve may also be referred to as a “control power level” or “control level.”

In the time window 302b, the area between Pmax and Preserve for the time duration of transmitting at Pmax may be equal to the area between Pₗᵢₘᵢₜ and Preserve for the time window T, such that the area of transmit power (P (t)) in the time window 302b is equal to the area of Pₗᵢₘᵢₜ for the time window T. Such an area may be considered using 100% of the energy (transmit power or exposure) to remain compliant with the time-averaged RF exposure limit. Without the reserve power Preserve, the transmitter may transmit at Pmax for a portion of the time window with the transmitter turned off for the remainder of the time window to ensure compliance with the time-averaged RF exposure limit.

In some aspects, the wireless device may transmit at a power that is higher than Pₗᵢₘᵢₜ, but less than Pmax in the time-averaged mode illustrated in the time window 302b. While a single transmit burst is illustrated in the time window 302b, it will be understood that the wireless device may instead utilize a plurality of transmit bursts within the time window (T), where the transmit bursts are separated by periods during which the transmit power is maintained at or below Preserve. Further, it will be understood that the transmit power of each transmit burst may vary (either within the burst and/or in comparison to other bursts), and that at least a portion of the burst may be transmitted at a power above Pₗᵢₘᵢₜ.

In certain aspects, the wireless device may transmit at a power less than or equal to a fixed power limit (e.g., Pₗᵢₘᵢₜ) without considering past exposure and/or past transmit powers in terms of a time-averaged RF exposure. For example, the wireless device may transmit at a power less than or equal to Pₗᵢₘᵢₜ using a look-up table (comprising one or more values of Pₗᵢₘᵢₜ depending on an RF exposure scenario). The look-up table may provide one or more values of Pₗᵢₘᵢₜ depending on the transmit frequency, transmit antenna, radio configuration (single-radio or multi-radio) and/or RF exposure scenario (e.g., a device state index corresponding to head exposure, body or torso exposure, extremity or hand exposure, and/or hotspot exposure) encountered by the wireless device. Examples of RF exposure scenarios include cases where the wireless device is emitting RF signals proximate to human tissue, such as a user's head, hand, or body (e.g., torso), or where the wireless device is being used as a hotspot away from human tissue. Therefore, the RF exposure can be managed as a time-averaged RF exposure evaluation (e.g., illustrated in FIG. 3), managed using a look-up table or flat or maximum value, or using another strategy or algorithm, where a particular process of managing the RF exposure may be referred to herein as an RF exposure control scheme.

For certain aspects, a wireless device may exhibit or be configured with a transmission duty cycle. The wireless device may determine transmit power level(s) and/or reserve power level(s) in compliance with the time-averaged RF exposure limit based on the duty cycle. The transmission duty cycle may be indicative of a share (e.g., 5 ms) of a specific period (e.g., 500 ms) in which the wireless device transmits RF signals. The duty cycle may be a ratio of the share to the specific period (e.g., 100 ms/500 ms), where the duty cycle may be represented as a number from zero to one. For example, in the time window 302a, the duty cycle may be greater than 50% of the duration of the time window (T), whereas in the time window 302b, the duty cycle may be equal to 100% of the duration of the time window (T).

In certain cases, the duty cycle may be standardized (e.g., predetermined) with a specific RAT and/or vary over time, for example, due to changes in radio conditions, mobility, and/or user behavior. As an example, certain RATs may specify the uplink duty cycle in the form of a time division duplexing (TDD) configuration, such as a TDD uplink-downlink (UL-DL) slot pattern in 5G NR or similar TDD patterns in E-UTRA or UMTS. In 5G NR, the TDD UL-DL slot pattern may specify the number of uplink slots and corresponding position in time associated with the uplink slots in a sequence of slots, such that the total number of uplink slots with respect to the total number of slots in the sequence is indicative of the duty cycle. In certain aspects, the duty cycle may correspond to the actual duration for past transmissions scheduled or used, for example, within the TDD UL-DL slot pattern. For example, although the wireless device may be configured with a TDD UL-DL slot pattern, the wireless device may use a portion or subset of the UL slots for transmitting RF signals. Thus, the duty cycle for the wireless device may be less than the maximum available duty cycle corresponding to the TDD UL-DL slot pattern.

In some cases, a controller (e.g., a WWAN modem) may control the RF exposure exhibited by WWAN radios in addition to other radios (e.g., RFID radio(s), WLAN radio(s) and/or Bluetooth radio(s)). For example, in some such configurations, the controller may implement the RF exposure manager 106.

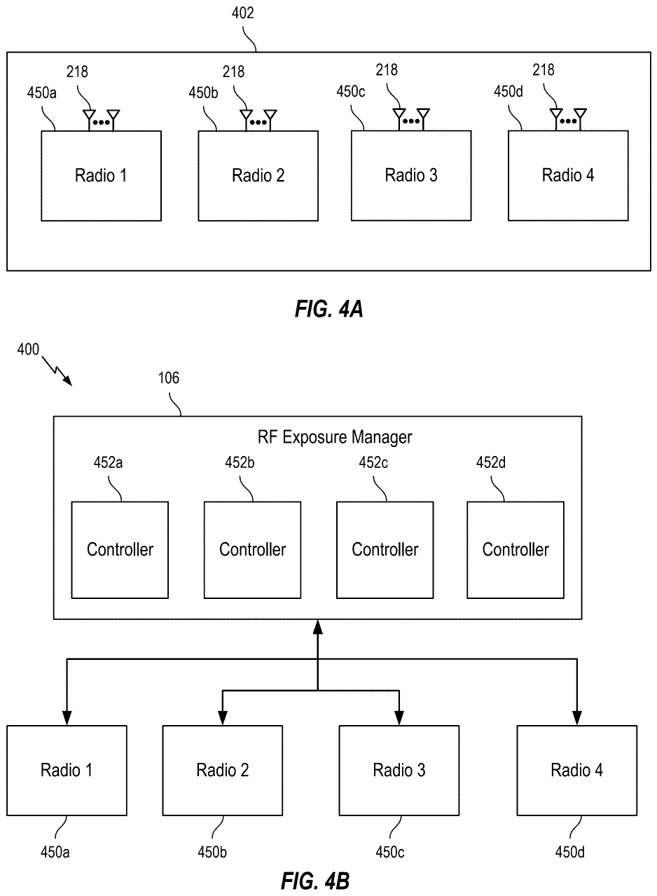

FIG. 4A is a diagram illustrating an example wireless device 402 (e.g., the wireless device 102) having multiple radios 450a-450d (collectively, “the radios 450”). The radios 450 may be similar to the radio(s) 250 of the wireless device 102 depicted in FIG. 2. In the example depicted in FIG. 4A, the radios 450a-450d may be associated with any of various RATs and/or frequency bands. For example, the radio 450a (or radio 1) may communicate via WWAN RAT(s) (e.g., E-UTRA and/or 5G NR) in sub-6 GHz frequency bands. The radio 450b (or radio 2) may communicate via RFID RAT(s) in sub-6 GHz frequency bands. The radio 450c (or radio 3) may communicate via WLAN RAT(s) in sub-6 GHz (e.g., 2.4 GHz, 5 GHZ, and/or 6 GHz) frequency bands. The radio 450d (or radio 4) may communicate via short-range communications (e.g., Bluetooth) in a 2.4 GHz frequency band. While this example shows a wireless device having four radios, a wireless device may have any number of radios for wireless communications, such as a radio per frequency band associated with RFID, WWAN and/or WLAN communications, a radio per RAT, or a radio capable of communicating via multiple RATs, as illustrative, non-limiting examples. Further, while the radios are illustrated as being separate, two or more of the radios may share components or circuitry. For example, portions of a signal path may be shared. The shared portion may include a shared or common mixer, filter, amplifier, and/or ADC or DAC, etc.

FIG. 4B is a diagram illustrating an example logical architecture 400 for controlling the transmit power (and hence, the RF exposure) associated with one or more radios (e.g., the radios 450a-450d) of a wireless device (e.g., the wireless device 404). The RF exposure manager 106 may operate as a primary controller for controlling the RF exposure associated with the radios 450a-450d. The primary controller may be a central controller for determining the maximum allowed transmit powers and/or transmit duration that can be used for a future time interval based on past transmit powers associated with all of the radios 450a-450d. For example, the RF exposure manager 106 may periodically (e.g., every 500 milliseconds (ms)) receive certain information from the radios 450a-450d, where the information may include, for example, a requested transmit power or exposure margin for a future time interval (e.g., the time interval 306, 308) and/or past transmit power history associated with a time interval (e.g., the past time interval 304) and/or averaging time window (e.g., the time window 302) or indication of whether a radio was on (active) or transmitting during the time interval and/or averaging time window. The RF exposure manager 106 may periodically (e.g., every 500 ms) provide each of the radios with an RF exposure margin or maximum allowed transmit power as well as a transmit duration for a future time interval (e.g., the future time interval 306, 308).

The primary controller may include any of a number of controllers (e.g., the controller 452a, the controller 452b, and/or the controller 452c). The controller 452a may represent the WWAN modem, the controller 452b may represent the WLAN modem, the controller 452c may represent the Bluetooth modem, and the controller 452d may represent the RFID modem, for example. Thus, while the controllers 452 are illustrated separate from the radios 450, the controllers 452 and/or certain functionality thereof may be included within or integrated with respective radios 450. The controllers 452 are illustrated as being within the RF exposure manager 106, but one or more of the controllers 452 may be implemented external to the RF exposure manager 106. Further, while certain of the controllers 452 are described as being associated with or configured to implement functionality of a particular radio and/or RAT, one or more of the controllers 452 may be agnostic with respect to radios and/or RATs, and/or may be shared by multiple radios. For example, a controller 452 may be included in an applications processor.

In some cases, a controller may take control of its own power limit and operate in a standalone manner (or mode) in response to the primary controller being in a particular state (e.g., idle mode, inactive, sleep mode, low power state, etc.). For example, when the controller 452a switches to a sleep or idle mode (e.g., due to the wireless device switching to reduced power mode), the controller 452b may operate in a standalone mode controlling the RF exposure associated with the radio 450c, and in some cases, the controller 452c may operate in standalone mode controlling the RF exposure associated with the radio 450d.

The primary controller (e.g., the controller 452a) may provide the other controllers 452b, 452c, 452d with certain information. For example, the primary controller may indicate to the other controllers that the primary controller is going to a state where the primary controller can no longer operate as the primary controller (for a particular or indefinite time). Additionally, the primary controller may indicate to the other controllers a respective transmit power budget (e.g., RF exposure budget or RF exposure margin) and/or transmit duration that applies for the radio(s) and/or RAT(s) while the primary controller is unable to operate as the primary controller (e.g., for the particular or indefinite time). The transmit power budget and/or transmit duration may be allocated to each radio and/or RAT in a manner to ensure compliance with the RF exposure limit. In general, the cumulative target powers associated with the radio(s) and/or RAT(s) may satisfy the RF exposure limit. For example, the controller 452b (and/or radio(s) 450 associated therewith) may be allocated 30% of the RF exposure budget for a given time window, the controller 452c (and/or radio(s) 450 associated therewith) may be allocated 40% of the RF exposure budget for the time window, and the controller 452d (and/or radio(s) 450 associated therewith) may be allocated 30% of the RF exposure budget for a given time window.

The primary controller may instruct the other controllers to use specific RF exposure calculations—for example, an RF exposure compliance algorithm (e.g., time-averaging or a particular maximum transmit power) with a preset parameter (e.g., RF exposure budget or transmit power level)—to control each of the other controllers' own power limits in a standalone manner. The RF exposure compliance algorithm may be the same or different among the controllers. For example, the complexity of the algorithms or calculations may be considered when instructing the controllers. It may be unnecessary for certain controllers to evaluate the same number of and/or type of criteria, and/or the controllers may have varying capabilities.

### Example Transmit Antenna Grouping

In certain cases, the wireless device may evaluate RF exposure compliance in terms of one or more antenna groups, where an antenna group may be a collection of antennas and/or antenna modules. The antenna groups may be treated mutually exclusive of each other in terms of RF exposure. For example, the wireless device may evaluate the RF exposure compliance for an antenna group independently of the RF exposure compliance for another antenna group. The antenna groups may be static or dynamic. The antennas and/or antenna modules may support multiple RATs.

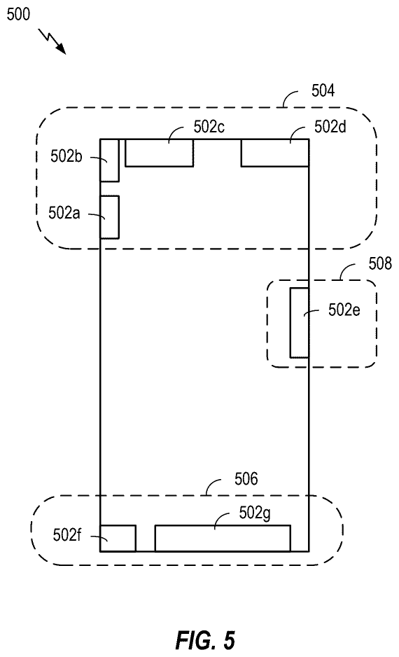

FIG. 5 is a block diagram illustrating an example grouping of multiple antennas of a wireless communication device 500, in accordance with certain aspects of the present disclosure. In this example, the wireless communication device 500 (e.g., a UE 120, such as a smartphone, or any of the wireless communication devices described herein) includes a first antenna 502a, a second antenna 502b, a third antenna 502c, a fourth antenna 502d, a fifth antenna 502e, a sixth antenna 502f, and a seventh antenna 502g. In this example, the antennas 502a-502g are separated into three antenna groups 504, 506, 508, which roughly correspond to a top of the device 500, a bottom of the device 500, and a side of the device 500, when the device 500 is held in the upright position. Those of skill in the art will appreciate that more or less than seven antennas may be implemented, and/or more or less than three antenna groupings may be defined. Each of the illustrated antennas 502a-502g may represent a single antenna, an array (e.g., a phased array) of antennas, or a module including one or more antennas. The antenna groups 504, 506, 508 may each include one or more antennas that are configured to transmit in a certain frequency band (e.g., very high (e.g., mmWave bands), high (e.g., 6-7 GHz bands), medium (e.g., 3-6 GHz bands), or low (e.g., 400 MHz-3 GHz bands)), or the antenna groups may each include one or more antennas that are configured to transmit in multiple frequency bands.

The antenna groupings described herein may be assigned into various antenna groupings (such as a mmWave grouping, a sub-6 GHz grouping, a low band grouping (e.g., 400 MHZ-3 GHz bands), a mixed-mode grouping (e.g., mmWave and sub-6 GHz grouping), a multi-RAT grouping (e.g., RFID, WWAN and WLAN), groupings for different exposure scenarios and/or device positions relative to the user's body, etc.), for example, for differing transmit scenarios. As an example, under a mmWave grouping, each mmWave module (e.g., the first antenna 502a, the third antenna 502c, and the fifth antenna 502e) may be treated as a separate antenna group, where each mmWave module may have multiple antenna elements (e.g., 4, 5, 8, 10, etc. dual polarization antenna elements) arranged in one or more arrays. The mmWave module may be capable of transmitting various beams via predefined antenna configurations, where the beams may form a codebook. Under a sub-6 GHz grouping, sub-6 GHz antennas may be grouped into separate groups. For example, the second and fourth antennas 502b, 502d may be assigned to a group, and the sixth and seventh antennas 502f, 502g may be assigned to another group. In certain cases, the antennas 502a-502g may be assigned to a mixed-mode grouping, such as the three antenna groups 504, 506, 508. Each antenna may be included in a separate antenna group, as illustrated, or one or more antennas may be included in multiple antenna groups.

The antenna groups may be defined and/or operated so as to be mutually exclusive in terms of RF exposure. In certain aspects, the transmit power of one or more of the antenna groups (or of one or more of the antennas within one or more groups) may be reduced such that the (normalized) sum of the exposure of all antenna groups, or of the overlapped RF exposure distributions, is less than a particular value (e.g., 1.0). For example, backoff factors may be determined for one or more groups, or one or more antennas within one or more groups, and applied so as to limit transmission power for the antenna(s) and/or groups. In certain aspects, antennas in different antenna groups are far enough away from each other such that the antennas' exposures do not overlap in the range in which exposure to a user is measured or defined. In certain aspects, existing regulatory approaches that meet predefined criteria like SAR peak location separation ratio (SPLSR) may be used to determine such mutual exclusivity (for example, as described in Section 4.3.2c of the Federal Communications Commission (FCC) Knowledge Database (KDB) 447498 D01 General RF Exposure Guidance v06). The mutual exclusivity of the antenna groups may enable the RF exposure manager 106 to determine the time-averaged RF exposures for each of the antenna groups in parallel with (e.g., independent of) each other.

In some examples, antenna groups for a device (e.g., the wireless device 102) are defined in documents presented to and/or published by a regulatory body during the process of demonstrating or certifying that the device complies with RF exposure regulations.

The antenna groups are static in some examples. In other examples, the antenna groups change over time or based on the scenario.

### Example RF Exposure Compliance for RFID Communications

In certain cases, a wireless device (e.g., the wireless device 102 illustrated in FIGS. 1-2) may include one or more radios (e.g., radio 250 illustrated in FIG. 2) that support an RFID RAT (referred to herein as RFID radio(s)). In such cases, the wireless device may control or manage the RF exposure of the RFID radio(s) in compliance with an RF exposure limit. In certain cases, the wireless device may control the transmit power level of the RFID radio and/or the transmit duration (at the transmit power level) of the RFID radio using various techniques described herein in order to maintain RF exposure compliance.

The wireless device may control RF exposure of the RFID radio for a (running) time window (e.g., 4 seconds for millimeter wave (mmWave), 2 seconds for 60 gigahertz (GHz) bands, 100 or 360 seconds for bands less than or equal to 6 GHz, etc.) in compliance with an RF exposure limit. In some cases, the wireless device may perform an RF exposure assessment of past RF exposure over a given time window to determine a maximum allowable transmit power and/or transmit duration for a future time interval in the time window. The wireless device may provide a transmit power limit (or allocation or budget) and/or a transmit duration to the RFID radio that applies for a specific time interval of the (running) time window, in compliance with the RF exposure limit. In some cases, compliance with the RF exposure limit may be performed as a time-averaged RF exposure evaluation within a specified running (moving) time window associated with the RF exposure limit.

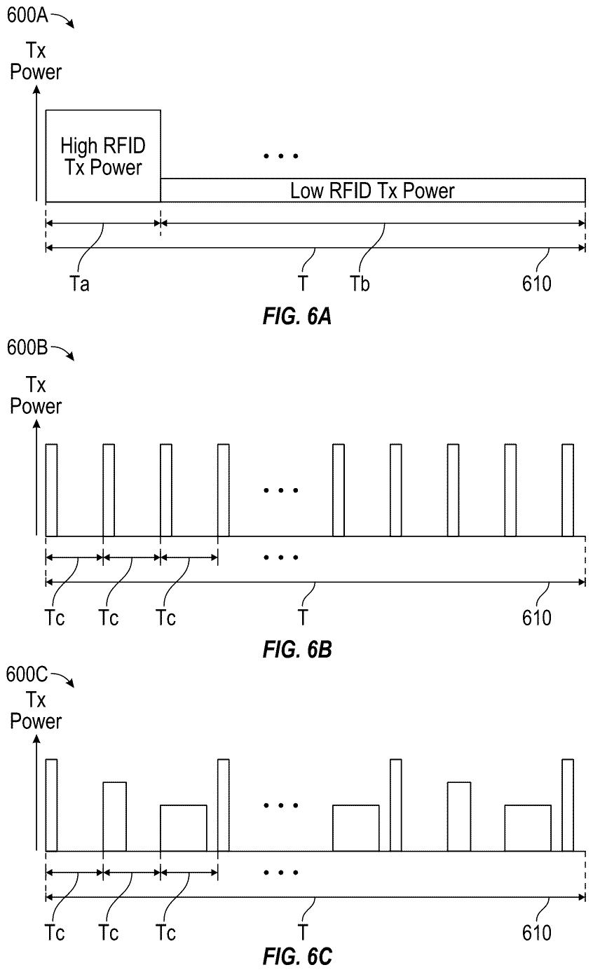

Consider FIGS. 6A-6C depicting various examples of RF exposure compliance for RFID communications, in accordance with certain aspects of the present disclosure.

FIG. 6A depicts a scenario 600A in which the wireless device may not control (e.g., cap) the RF exposure budget that is available to the RFID radio for an RFID transmission within a (running) time window (T) 610 (e.g., time-averaging window) associated with an RF exposure limit (e.g., time-averaged RF exposure limit). In some cases, the scenario 600A may be used for short-scan applications in which the wireless device is used to scan/detect a few number of tags. For example, in such cases, it may be desirable for the RFID radio to transmit at a maximum allowable transmit power level for a short duration, e.g., to increase the likelihood of successful communication with the tags in that short duration.

However, one potential drawback to the scenario 600A depicted in FIG. 6A is that the wireless device may use most or all of the RF exposure budget (or RF exposure margin) associated with the RF exposure limit for a high-power RFID transmission in a short duration (e.g., time interval Ta) relative to the time window (T) 610. In cases where a high-power RFID transmission uses most or all of the RF exposure budget in a short duration, the wireless device may maintain the transmit power for the RFID radio at a reserve level (e.g., lower transmit power level) for the remainder of the time window (T) 610 (e.g., time interval Tb) or may refrain from sending RFID transmissions for the remainder of the time window (T) 610 (e.g., time interval Tb) to ensure compliance with the RF exposure limit. In these cases, the performance of the RFID radio during the remainder of the time window may be impacted in terms of lower tag detection (or read) rates, lower tag detection (or read) ranges, and/or increased latency, as illustrative examples.

FIG. 6B depicts a scenario 600B in which the wireless device may control (e.g., cap) the RF exposure budget that is available to the RFID radio for one or more RFID transmissions within a (running) time window (T) 610 (e.g., time-averaging window) associated with an RF exposure limit (e.g., time-averaged RF exposure limit). As shown in FIG. 6B, during each time interval Tc within the time window (T) 610, the wireless device allocates a fixed transmit power and a fixed transmit duration to the RFID radio to use for an RFID transmission during the time interval Tc. The scenario 600B may be used for RFID applications in which the wireless device is used to detect a large number of tags. In such applications, it may be desirable to maintain the performance of the RFID radio (e.g., in terms of tag detection rate, tag detection range, etc.) at a consistent level for an entirety of (or a substantial portion of) the time window (T) 610.

FIG. 6C depicts another scenario 600C in which the wireless device may control (e.g., cap) the RF exposure budget that is available to the RFID radio for one or more RFID transmissions within a (running) time window (T) 610 (e.g., time-averaging window) associated with an RF exposure limit (e.g., time-averaged RF exposure limit). Compared to scenario 600B depicted in FIG. 6B, the wireless device in scenario 600C may adjust the transmit power and/or transmit duration that is allocated to the RFID radio to use for an RFID transmission during each time interval Tc. For example, the wireless device may adjust the transmit power and/or transmit duration in different RFID transmission frames to achieve different target tag detection rates and target tag detection ranges. In some examples, the energy used in each time interval Tc is consistent between scenario 600B and 600C. In some such examples, a longer transmission time may enable more tags to be read, while a higher transmission power may allow for tags located a farther distance away to be read.

In certain aspects, one or more of the scenarios 600A-600C may be applicable to standalone RFID radio scenarios (e.g., when the RFID radio is the sole active radio and other radios/RATs, such as a WWAN radio/RAT, a WLAN radio/RAT, and a Bluetooth radio/RAT, are inactive). In standalone RFID radio scenarios, all of the RF exposure budget for a given time window (e.g., time window (T) 610) may be available to the RFID radio(s) for one or more RFID transmissions.

Alternatively, in certain aspects, one or more of the scenarios 600A-600C may be applicable to the RFID radio operating concurrently with one or more other radios/RATs, such as a WWAN radio/RAT, a WLAN radio/RAT, and a Bluetooth radio/RAT. In concurrent radio scenarios involving the RFID radio and one or more other radios/RATs, the RF exposure budget that is available to the RFID radio may be capped in order to achieve a sustainable RFID performance for a time window. Additionally or alternatively, the RF exposure budget that is available to other radios/RATs may be capped as well.

In certain aspects, in concurrent radio scenarios involving the RFID radio and one or more other radios/RATs, the wireless device may determine the RF exposure budget that is available to the RFID radio in a given time window based on a reserve determined for each of the RFID radio and the one or more other radios/RATs.

For example, in certain aspects, a wireless device may allocate a minimum reserve among radios in an antenna group where the radios communicate via multiple RATs, such as RFID, WLAN, WWAN, and/or Bluetooth, as illustrative examples. The wireless device may allocate the minimum reserve among the radios that will be actively transmitting at the same time.

In certain aspects, the wireless device may be configured with specific reserve information per antenna group, such as the antenna groups described herein with respect to FIG. 5. At least one of the antenna groups may be associated with three or more radios. The radios may communicate via two or more different RATs in some examples, where the different RATs may include a combination of RFID and WWAN, a combination of RFID and WLAN, a combination of RFID and Bluetooth, a combination of WWAN, WLAN, Bluetooth, and RFID, a combination of WWAN and WLAN, a combination of WWAN and Bluetooth, a combination of WLAN and Bluetooth, or a combination of WWAN, WLAN, and Bluetooth, for example. The reserve information may include a minimum reserve, NE_{totalMinRsv,AGk}, shared among two or more of the radios and radio-specific split ratio(s). Each of the radios associated with the shared minimum reserve may be configured with a split ratio used to determine the portion of the shared minimum allocated to the respective radio. Such a configuration for an antenna group may allow the wireless device to efficiently allocate the reserve across radios communicating via different RATs. The minimum reserve may be shared among radios that are transmitting simultaneously with each other or in the same time interval. As an example, if two of the radios in the antenna group are transmitting at the same time, the wireless device may divide the minimum reserve between those radios, as further described herein.

The wireless device may be configured with a split ratio per radio associated with a shared minimum reserve. For a radio in an active state (e.g., radio (i)), the portion (reserve_{radio(i)}) of the minimum reserve for a particular antenna group (NE_{totalMinRsv,AGk}) may be determined according to the following expression:

$${Reserve}_{radio ( i )} = \frac{radio ( i ) \cdot split\_ratio}{\sum radio ( active ) \cdot split\_ratio} \cdot {NE}_{totalMinRsv , AGk} \qquad ( 1 )$$

where radio (i).split_ratio is the split ratio for the radio (i), Σ radio(active). split_ratio is the sum of split ratio(s) for radio(s) in an active state (e.g., actively transmitting in the same transmission occasion or time interval of a time window associated with a time-averaged RF exposure limit), and i is the index for each radio in the active state. A radio in an active state may refer to a radio that could be or will be transmitting in a particular transmission occasion or (future) time interval of a time window associated with a time-averaged RF exposure limit. For example, a radio in an active state may correspond to when the radio is (or could be or will be) actively transmitting in a transmission occasion or time interval of the time window. The portion of the reserve allocated to the radio(s) that are not in the active state may be set to the remaining portion of the minimum reserve, such as zero.

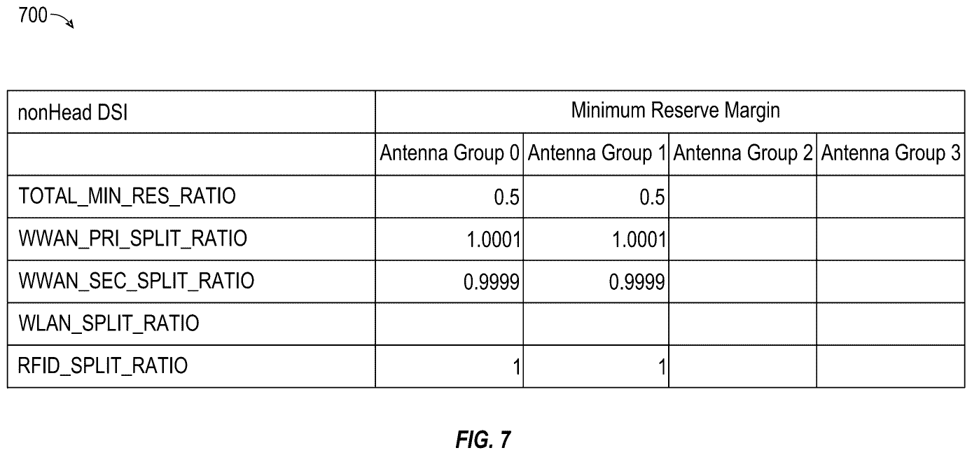

FIG. 7 is a table 700 illustrating example split ratios for multiple radios/RATs across different antenna groups (antenna group 0 (AG0) and antenna group 1 (AG1)) for a given transmit scenario (e.g., nonHead device state index (DSI)), according to certain aspects of the present disclosure. In this example, the wireless device is configured with a total minimum reserve ratio (total_min_res_ratio), a split ratio for a primary WWAN radio (WWAN_pri_split_ratio), a split ratio for a secondary WWAN radio (WWAN_see_split_ratio), a split ratio for a WLAN radio (WLAN_split_ratio), and a split ratio for an RFID radio (RFID_split_ratio). It will be appreciated that the split ratio values depicted in table 700 are merely examples, and that the split ratio values may be different for different transmit scenarios.

In certain aspects, the wireless device may determine a reserve for each of the RFID radio and the one or more other radios/RATs, based at least in part on services mapped to the radios. For example, a wireless device may allocate reserve to the radios based on services mapped to the radios, such that each radio has at least a minimum service reserve available for the service(s) mapped to the radio.

In certain aspects, the wireless device may be configured with specific reserve information per service and antenna group, such as the antenna groups described herein with respect to FIG. 5. At least one of the antenna groups may be associated with three or more radios. The radios may communicate via two or more different RATs in some examples, where the different RATs may include, for example, a combination of RFID and WWAN, a combination of RFID and WLAN, a combination of RFID and Bluetooth, a combination of WWAN, WLAN, Bluetooth, and RFID, a combination of WWAN and WLAN, a combination of WWAN and Bluetooth, a combination of WLAN and Bluetooth, or a combination of WWAN, WLAN, and Bluetooth. The reserve information may include, for each service supported by the wireless device, an indication of multiple minimum service reserves that should be allocated to the service, where each of the minimum service reserves is associated with a respective RAT. The wireless device may use the reserve information along with an indication of a current state associated with each respective service mapped to one or more radios to determine the portion of a reserve to allocate to the respective radio. Such a configuration may ensure that each service mapped to a given radio and in an active or parked state is allocated a sufficient amount of reserve to provide for a desired level of performance. Note, as used herein, a service in a “parked” state (or “park” mode) may refer to a service that is not currently active, but may start at any time. A service in an “active” state (or “active” mode) may refer to a service that is currently active.

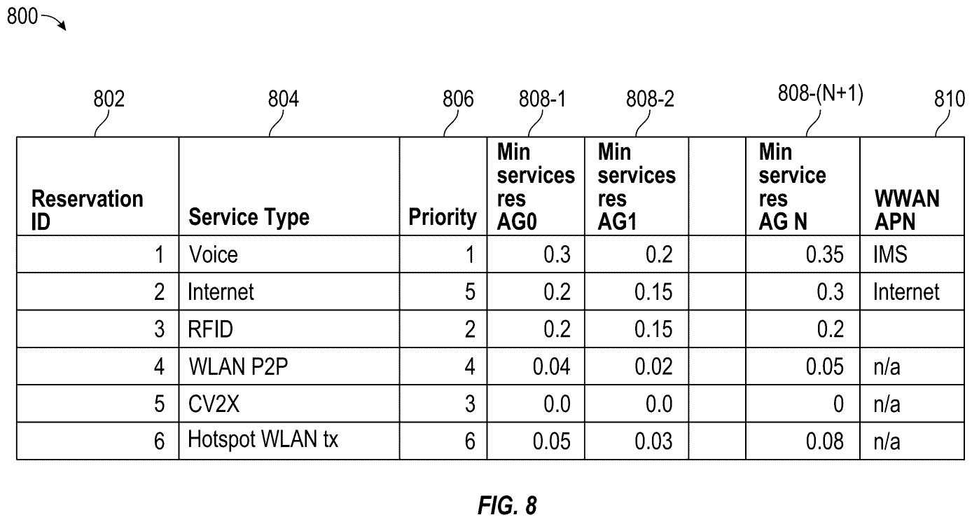

FIG. 8 is a table 800 illustrating example reserve information for multiple services for multiple antenna groups, according to certain aspects of the present disclosure. In certain aspects, the table 800 is a semi-static table, which may be configured by an original equipment manufacturer (OEM) of a wireless device.

In this example, each row in the table 800 corresponds to a different service (or service type), such as voice traffic, Internet traffic, RFID traffic, WLAN P2P traffic, cellular vehicle-to-everything (CV2X) traffic, and hotspot WLAN traffic, as illustrative, non-limiting examples. For each row, the table 800 includes a reservation identifier (ID) field 802, a service type field 804, a priority field 806, one or more minimum service reserve fields 808, and a WWAN access point name (APN) field 810.

The reservation ID field 802 includes a unique identifier for the respective service type. In table 800, for example, voice traffic has a reservation ID= “1,” Internet traffic has a reservation ID= “2,” RFID traffic has a reservation ID= “3,” WLAN P2P traffic has a reservation ID= “4,” CV2X traffic has a reservation ID= “5,” and hotspot WLAN traffic has a reservation ID= “6.” These numbers are just examples, and different numbers may be used to represent the various service types. Note that while FIG. 8 depicts the reservation ID field 802 having an integer data type, other data types (e.g., alphanumeric data type, string data type, etc.) are also contemplated.

The service type field 804 is generally a string that indicates the particular service type (e.g., voice traffic, Internet traffic, RFID traffic, WLAN P2P traffic, CV2X traffic, and hotspot WLAN traffic, as illustrated). Note that the services depicted in table 800 are provided as reference examples of services that can be configured for a wireless communication device and that the table 800 can include any number of services as well as different types of services. In some examples, the service type field 804 is omitted.

The priority field 806 includes an indication of a priority level for each respective service. In table 800, for example, voice traffic has a priority level of 1, Internet traffic has a priority level of 5, RFID traffic has a priority level of 2, WLAN P2P traffic has a priority level of 4, CV2X traffic has a priority level of 3, and hotspot WLAN traffic has a priority level of 6, where the priority levels are in an ascending order of priority (that is, a lower priority level number indicates a relatively higher priority service). Note, however, that in other examples, the table 800 may include priority levels in a descending order of priority (where a higher priority level number indicates a relatively higher priority service). In yet other examples, indications of priority level other than numbers may be used, such as other alphanumeric characters or strings.

The minimum service reserve fields 808-1 to 808-(N+1) (collectively, minimum service reserve fields 808) indicate, for each service, an amount of reserve that should be allocated to the service for each antenna group (e.g., AG0 to AGN). For example, since different antenna groups may have different RF exposure limits (e.g., Plim), the minimum service reserve for a given service may be different for each antenna group. Thus, the varying reserves in table 800 may be representative of varying conditions that might exist for different radios and/or antennas in different antenna groups. Further, services might have differing priorities and/or transmission specifications depending on an antenna or radio used to operate with that service. In general, the table 800 includes an indication of the reserve for a service on all the antenna groups where that service can take place. The values in the minimum service reserve fields 808 may be listed in terms of normalized exposure (NE) reserve levels, which may be expressed as the minimum service reserve transmission power divided by Pₗᵢₘᵢₜ or another suitable value. A value of 0 (or another suitable indication) in the minimum service reserve fields 808 may be used to indicate that a certain service does not use a particular antenna group or that this service is in an off state.

Note, there may be instances where, within an antenna group, the minimum service reserve for a service on radio X (in the antenna group) may be different than the minimum service reserve for the service on radio Y (in the antenna group). In such instances, the table 800 may set the minimum service reserve for the antenna group to the maximum of the minimum service reserves for radios where a service can appear in the antenna group. Note, however, that in such instances, the table 800 may set the minimum service reserve for the antenna group according to another criteria, such as priority of the radios, as an illustrative example. In other examples, reserve information is additionally or alternatively provided in the table 800 for individual radios within the same antenna group. For instance, assuming a service is mapped to a radio X and a radio Y in the same antenna group, the table 800 may include the minimum service reserve for the service on radio X and the minimum service reserve for the service on radio Y within the antenna group.

The WWAN APN field 810 may be included for a service when the service is mapped to WWAN. For example, a radio that supports a WWAN access technology may support one or more different WWAN RATs, such as 5G NR, LTE, UMTS, Internet Protocol (IP) Multimedia Subsystem (IMS), and CDMA (e.g., 2G/3G RAT). Additionally, for uplink carrier aggregation in LTE and/or NR, each of the active component carriers used for wireless communications may be treated as a separate radio. For example, LTE and/or NR may support a master cell group (MCG) and a secondary cell group (SCG), where each of the MCG and SCG supports a primary component carrier (PCC) and one or more secondary component carriers (SCCs). Accordingly, when the WWAN APN field 810 is included for a service, the WWAN APN field 810 generally includes an indication of the particular WWAN radio to which the service is mapped.

In the example depicted in table 800, the WWAN APN field 810 for voice traffic indicates “IMS,” and the WWAN APN field 810 for Internet traffic indicates “Internet.” The wireless device may use the WWAN APN information to allocate the minimum service reserve to the appropriate radio for the service. For example, if the WWAN APN field indicates “IMS,” then the service may use the IMS bearer. The IMS bearer may be radio resource control (RRC) configured on the MCG/SCG in LTE or the MCG/SCG in NR. Assuming MCG is used, IMS may refer to the LTE PCC or frequency range 1 (FR1) PCC. Thus, when the WWAN APN field indicates “IMS,” the wireless communications device may assume that the radio is LTE PCC or FR1 PCC.

In other examples, if the WWAN APN field 810 indicates “Internet,” then the service may use the default bearer. The data link layer (e.g., in the open systems interconnection (OSI) model) can establish MCG and SCG for the default bearer along with the bearer type (e.g., LTE, FR1, and frequency range 2 (FR2)). Accordingly, in this example, the wireless communications device may assume that the service occurs on both PCC and SCC (of MCG and SCG if present). Thus, the value in the APN field need not represent an access point, but rather can represent a bearer or any other type of information that can be used to identify a radio configured for a service on a particular RAT (e.g., a radio in WWAN used for the service).

In certain aspects, the wireless device may generate real-time information about the state of each service (e.g., reservation ID field 802) indicated in the reserve information (e.g., table 800). In some examples, the real-time state information may be generated by an RF exposure manager (e.g., RF exposure manager 106) of the wireless device. In other examples, the real-time state information may be generated at run-time using a communication interface, such as a mobile station modem (MSM) interface. In yet other examples, the real-time state information may be generated at run-time by an applications processor.

In certain aspects, in addition to or as an alternative to determining a reserve for each of the RFID radio and one or more other radios/RATs based on split ratios or services mapped to the radio, the wireless device may allocate reserve to the RFID radio based on a request from the RFID radio or a dedicated reserve for the RFID radio. For example, in some aspects, the RFID radio may request its own dynamic reserve for RFID communications. In another example, the RFID radio may use a dedicated reserve for RFID communications, e.g., to achieve a target level of RFID performance.

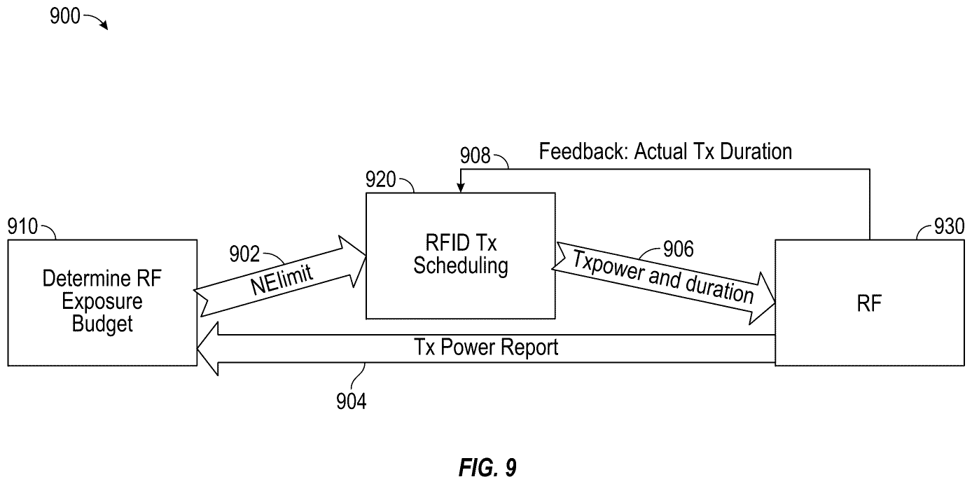

FIG. 9 illustrates a workflow 900 for controlling RF exposure of an RFID radio in compliance with an RF exposure limit (e.g., time-averaged RF exposure limit). The workflow 900 may be performed, for example, by a wireless device (e.g., the wireless device 102).

At block 910, the wireless device may determine an RF exposure budget available to the RFID radio for a future time interval (e.g., future 500 ms or some other amount of time) within a time window (e.g., time-averaging time window) using one or more techniques described herein. In certain examples, the wireless device may determine the RF exposure budget based on a total normalized power report (e.g., total consumed exposure or normalized exposure) of past transmit powers for one or more transmitters over a prior time interval within the time window (e.g., time-averaging time window). In such some examples, the RF exposure budget may represent a normalized exposure (NE) margin allowed for the future timer interval in the time window such that the time average of a normalized power report and the exposure margin for the future time interval satisfy a time-averaged RF exposure limit. In some cases, the NE margin may be the maximum RF exposure that the wireless device can produce and satisfy the time-averaged RF exposure limit. The NE margin may be the percentage of exposure remaining with respect to the normalized power report and the time-averaged RF exposure limit. For example, the time-averaged RF exposure limit may be satisfied when the time average of the normalized power report and the exposure margin for the next time interval is less than or equal to the normalized RF exposure limit (NElimit) 902. In the example depicted in FIG. 9, the RF exposure budget is represented as the NElimit 902. For example, a controller (e.g., controller 452, such as in an RF exposure manager 106) may determine and provide the RF exposure budget (e.g., the NElimit 902) to an RFID radio. The RF exposure budget may be based on how other radios, for example in a same antenna group, have been or are being utilized.

At block 920, the wireless device may perform RFID transmit scheduling, based at least in part on the NElimit 902. As part of the RFID transmit scheduling, the wireless device may determine a transmit power and/or a transmit duration (depicted as Tx_power and duration 906) for the RFID radio that applies during the future time interval. For example, based on the received transmit budget (e.g., NElimit 902), the RFID radio may determine the duration and/or power based on a number of tags to be read and/or a distance to the tags, as described above with respect to FIG. 6B and FIG. 6C. In some cases, at block 920, the wireless device (e.g., the RFID radio) may cap the RF exposure budget that is available to the RFID radio during the future time interval. In some such cases, the wireless device may cap the RF exposure budget so that a consistent amount of transmit power energy is available to the RFID radio during each time interval within the time window. Capping the RF exposure budget that is available to the RFID radio during each of one or more future time intervals within the time window may allow the RFID radio to sustain a target performance (e.g., target tag detection rate and/or target tag detection range) for RFID communications during the time window, e.g., as described above with respect to FIG. 6B and FIG. 6C.

In certain examples, the wireless device may cap the RF exposure budget using the following Equation (2), determine the transmit power based on user input and/or application scenario, and determine the transmit duration using the following Equation (3):

$$RF Exposure Budget = min ( NElimit , cap ) * {P}_{limit} * time interval duration \qquad ( 2 )$$

$$Transmit duration = min ( NElimit , cap ) * Plimit * time interval duration / ( maxDC * Txpower ) \qquad ( 3 )$$

where maxDC is the maximum duty cycle for the RFID radio and “cap” is a parameter used for capping the RF exposure budget for the RFID radio. In some aspects, the initial value of “cap” may be equal to 1. Setting the initial value of “cap”=1 may ensure that a consistent amount of transmit power energy (e.g., approximately equal amount of transmit power energy) is available across all time intervals within the time window. Note, however, that “cap” may be set to any value. For example, in certain aspects, the initial value of “cap” may be greater than 1. Setting the initial value of “cap”>1 may allow the RFID radio to transmit at a higher power for one or more future time intervals, albeit at the cost of potentially being unable to sustain the higher power for an entirety of the time window (e.g., later during the time window). As noted, in some cases, a higher transmission power may allow for tags located a farther distance away to be read compared to a lower transmission power. In other aspects, the initial value of “cap” may be less than 1. Setting the initial value of “cap”<1 may allow the RFID radio to transmit at the same power for the entire time window while maintaining (or reserving) an unused portion of the RF exposure budget. For example, “cap” may be set to a value less than 1 in cases where the RFID radio is operating conservatively (e.g., communicating with fewer tags than anticipated, communicating with tags located a close distance away from the RFID radio, or a combination thereof). This unused portion of the RF exposure budget may be allocated to one or more other radios/RATs of the wireless device and/or allocated to the RFID radio in one or more future time windows, as illustrative examples.

At block 930, the wireless device may provide the transmit power and the transmit duration to transceiver circuitry (e.g., the modem 212 illustrated in FIG. 2 and/or components in the TX path). For example, the transceiver circuitry may obtain the transmit power and transmit duration as digital RF information (e.g., a particular gain index associated with an output power of the transmit path depicted in FIG. 2), and may control the gains applied to circuitry in the transmit path to output an RFID signal at the transmit power associated with the digital RF information. The wireless device (e.g., the RFID radio) may also generate a transmit power report 904, which may be used by the wireless device (e.g., the controller 452) for determining an RF exposure budget for a subsequent time interval of the time window associated with the RF exposure limit.

In certain aspects, the RFID radio may not fully transmit for the entirety of the allocated transmit duration due to long tune away, paging, and other reasons. For example, in cases where the RFID radio shares RF resources (e.g., antennas) with other radios/RATs, the RFID radio may be tuned away for a period of time to allow the other radios/RATs to use the RF resources. In another example, in cases where RFID is the standalone active radio, the RFID radio may tune away for paging and other activities, or the RFID radio may communicate with fewer tags than anticipated. In such aspects in which the RFID radio does not fully transmit for the entirely of the allocated transmit duration, the wireless device may allocate the unused RF exposure budget from the previous time interval to the RF radio for a subsequent time interval within the time window.

As depicted in FIG. 9, for example, at block 920, the wireless device (via RFID transmit scheduling) may obtain feedback 908 (e.g., from the transceiver circuitry) regarding the actual transmit duration of the RFID radio for the time interval. Upon receiving the actual transmit duration of the RFID radio, the wireless device may adjust the RF exposure budget that is available for a subsequent time interval, based in part on the unused RF exposure budget from the previous time interval. In some aspects, information represented in FIG. 9 as the feedback 908 is not received from an external source (e.g., from the transceiver or RF circuitry), but rather is known or determined within a component or system. For example, in some aspects the transmit duration is known or determined within the RFID radio and used by the RFID radio to adjust the RF exposure budget. In some aspects, the wireless device may update the initial value of the “cap” parameter in Equations (2) and (3), based at least in part on the unused RF exposure budget from the previous time interval, to allow the RFID radio to be allocated a greater amount of the RF exposure budget for the subsequent time interval within the time window. In some such aspects, the “cap” parameter may be updated using the following Equation (4):

$$cap = cap + ( ( transmit duration\_calculated \_prev - actual transmit duration ) * Txpower\_prev * maxDC / ( Plimit * time interval duration ) ) \qquad ( 4 )$$

After updating the “cap” parameter using Equation (4), the wireless device may determine the RF exposure budget for the subsequent time interval using Equation (2) (with the updated “cap” parameter), determine the transmit power based on user input and/or application scenario, and determine the transmit duration for the subsequent time interval using Equation (3) (with the updated “cap” parameter). In certain aspects, the wireless device may reset the “cap” parameter to an initial value (e.g., cap=1, cap <1, or cap>1) after each cycle (e.g., after determining the RF exposure budget and transmit duration for a given time interval).

### Example Operations for Wireless Communications

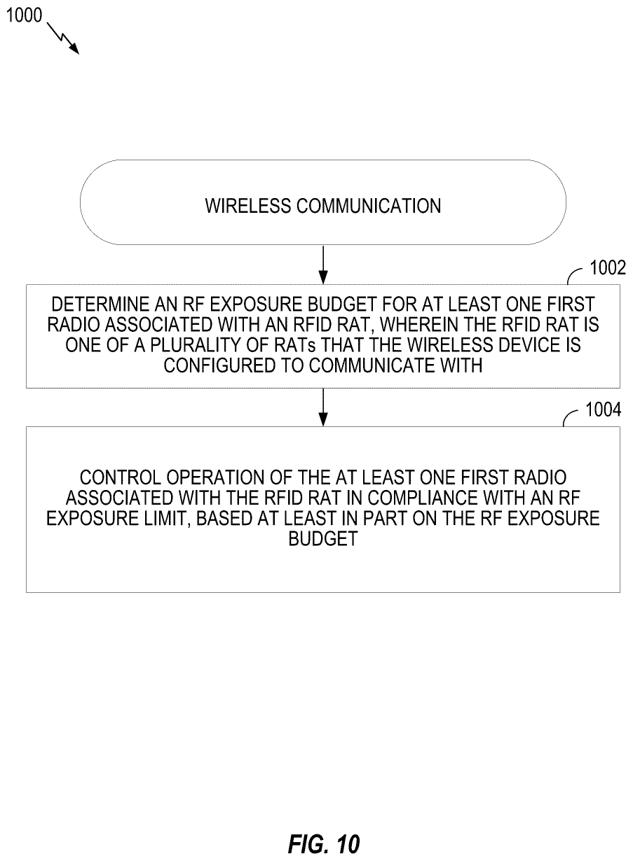

FIG. 10 is a flow diagram illustrating example operations 1000 for wireless communication. The operations 1000 may be performed, for example, by a wireless device (e.g., the wireless device 102 in the wireless communication system 100) and/or a processing system. The operations 1000 may be implemented as software components that are executed and run on one or more processors (e.g., the processor 210 and/or the modem 212 of FIG. 2). For example, at least operations 1002-1004 may be performed by a controller (e.g., controller 452), such as in an RF exposure manager (e.g., RF exposure manager 106) and/or dedicated to a particular radio (e.g., an RFID radio).

The operations 1000 may involve, at block 1002, determining an RF exposure budget for at least one first radio associated with an RFID RAT. The RFID RAT may be one of multiple RATs that the wireless device is configured to communicate with. For example, the multiple RATs may include the RFID RAT and one or more other RATs different from the RFID RAT, such as one or more WLAN RATs, one or more WWAN RATs, and/or one or more Bluetooth RATs, among other RATs.

The operations 1000 may also involve, at block 1004, controlling operation of the at least one first radio associated with the RFID RAT in compliance with an RF exposure limit, based at least in part on the RF exposure budget.

In certain aspects, controlling the operation of the at least one first radio associated with the RFID RAT may include (i) determining a first portion of the RF exposure budget that is available to the at least one first radio for a first time interval of a time window (e.g., time-averaging window) associated with the RF exposure limit (e.g., time-averaged RF exposure limit), (ii) determining at least one of a transmit power or a transmit duration, based on the first portion of the RF exposure budget and (iii) sending one or more RFID transmissions during the first time interval using the at least one first radio according to the at least one of the transmit power or the transmit duration. In some such aspects, the first portion of the RF exposure budget may be representative of a capped amount of the RF exposure budget. As noted, the RF exposure budget for the at least one first radio may be capped (e.g., to the first portion of the RF exposure budget) to allow the RFID radio to sustain a target communication profile (e.g., in terms of one or more target RFID communication metrics, such as target tag detection rate and/or target tag detection range) over the time window. In some such aspects, the first portion of the RF exposure budget may be determined using Equation (2) described herein, the transmit power may be determined based on user input and/or application scenario, and the transmit duration may be determined using Equation (3) described herein, for example.

In certain aspects, at least one of (i) the transmit power may be determined further based on a distance of at least one tag from the wireless device and/or the RFID radio thereof or (ii) the transmit duration may be determined further based on a number of the at least one tag to read.

In certain aspects, the first portion of the RF exposure budget may be determined based on one or more target RFID communication metrics for the time window. The one or more target RFID communication metrics may include a target tag detection rate, a target tag detection range, or any combination thereof. In certain aspects, the first portion of the RF exposure budget may be equal to each of one or more second portions of the RF exposure budget available to the at least one first radio for one or more respective second time intervals of the time window. As noted, in some such aspects, the RF exposure budget may be capped such that there is a consistent amount of energy available for the at least one radio in each time interval of the time window.

In certain aspects, the operations 1000 may further involve determining an unused portion of a second portion of the RF exposure budget determined for the at least one first radio for a second time interval of the time window (e.g., time-averaging window). In some such aspects, the second time interval may be prior to the first time interval. Additionally, in some such aspects, the first portion of the RF exposure budget may be determined further based on the unused portion of the second portion of the RF exposure budget determined for the second time interval. In some such aspects, the second portion of the RF exposure budget determined for the second time interval may be less than the first portion of the RF exposure budget determined for the first time interval. Additionally, in some such aspects, determining the first portion of the RF exposure budget may include adjusting a cap on the first portion of the RF exposure budget based on the unused portion of the second portion of the RF exposure budget determined for the second time interval. For example, the cap may be adjusted using Equation (4) described herein.

In certain aspects, the at least one first radio associated with the RFID RAT may be active during the first time interval and one or more second radios associated with one or more RATs different from the RFID RAT may be inactive during the first time interval. The one or more RATs different from the RFID RAT may include one or more WLAN RATs, one or more WWAN RATs, one or more Bluetooth RATs, or any combination thereof.

In certain aspects, the at least one first radio associated with the RFID RAT may be active during the first time interval and at least one second radio associated with at least one RAT different from the RFID RAT may be active during the first time interval. The at least one RAT different from the RFID RAT may include one or more WLAN RATs, one or more WWAN RATs, one or more Bluetooth RATs, or any combination thereof.

In some aspects, the RF exposure budget may be determined based at least in part on a reserve determined for each of the at least one first radio and the at least one second radio. In such aspects, the operations 1000 may further include: (i) obtaining reserve information associated with a plurality of services allocated to a set of antenna groups, each antenna group of the set of antenna groups being associated with at least one of the at least one first radio or the at least one second radio; and (ii) determining the reserve for each of the at least one first radio and the at least one second radio, based at least in part on the reserve information, a set of services of the plurality of services mapped to each of the at least one first radio and the at least one second radio, and a respective state associated with each of the set of services. In some aspects, the reserve information may indicate a plurality of minimum service reserves for each of the plurality of services. Each of the plurality of minimum service reserves may be associated with a respective antenna group of the set of antenna groups.

In some aspects, the RF exposure budget may be determined based at least in part on a reserve determined for each of the at least one first radio and the at least one second radio. In such aspects, the operations 1000 may further include: (i) obtaining reserve information associated with an antenna group associated with a plurality of radios including the at least one first radio and the at least one second radio; and (ii) determining the reserve for each of the plurality of radios based at least in part on the reserve information and an active state associated with each of the plurality of radios. In some aspects, the reserve information may include a total reserve associated with all of the plurality of radios in the antenna group. In some aspects, the reserve information may include a first reserve associated with the at least one first radio and a second reserve associated with the at least one second radio. In some aspects, the reserve information may include a split ratio associated with each of the plurality of radios sharing a total reserve.

### Example Communications Device

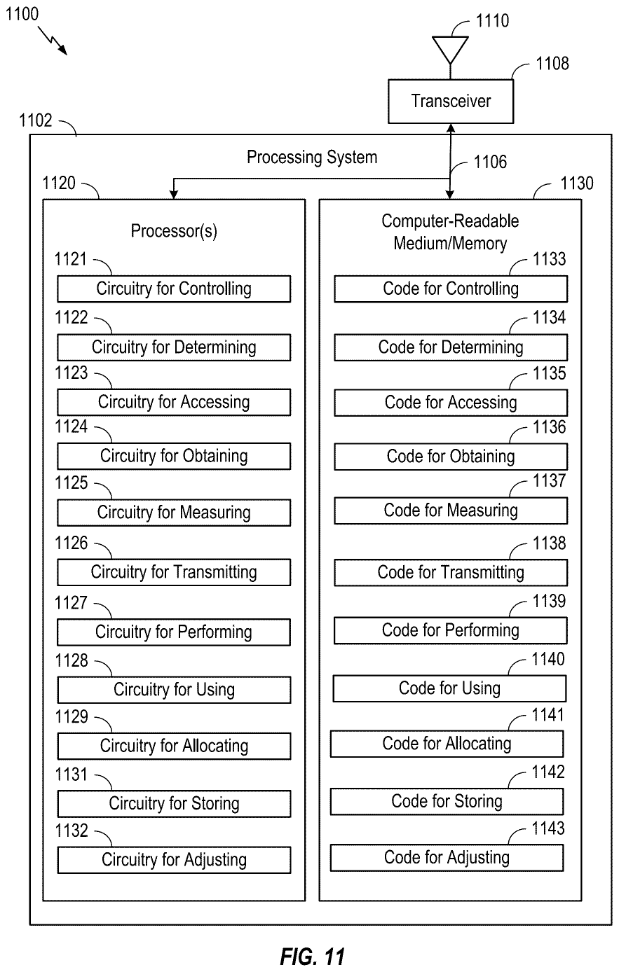

FIG. 11 depicts aspects of an example communications device 1100. In some aspects, communications device 1100 is a wireless communication device, such as the wireless device 102 described above with respect to FIGS. 1 and 2.

The communications device 1100 includes a processing system 1102 coupled to a transceiver 1108 (e.g., a transmitter and/or a receiver). The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes one or more processors 1120. In various aspects, the one or more processors 1120 may be representative of any of the processor 210 and/or the modem 212, as described with respect to FIG. 2. The one or more processors 1120 are coupled to a computer-readable medium/memory 1130 via a bus 1106. In certain aspects, the computer-readable medium/memory 1130 is configured to store instructions (e.g., computer-executable code) that when executed by the one or more processors 1120, cause the one or more processors 1120 to perform the operations 1000 described with respect to FIG. 10 or any aspect related to the operations described herein. Note that reference to a processor performing a function of communications device 1100 may include one or more processors performing that function of communications device 1100.

In the depicted example, computer-readable medium/memory 1130 stores code (e.g., executable instructions) for controlling 1133 (including code for operating, code for refraining, and code for ceasing), code for determining 1134 (including code for detecting, code for capping, and code for adjusting), code for accessing 1135, code for obtaining 1136, code for measuring 1137, code for transmitting 1138 (including code for sending), code for performing 1139, code for using 1140, code for allocating 1141, code for storing 1142, and code for adjusting 1143 (collectively referred to herein as code 1133-1143). Processing of the code 1133-1143 may cause the communications device 1100 to perform the operations 1000 described with respect to FIG. 10 or any aspect related to operations described herein.

The one or more processors 1120 include circuitry configured to implement (e.g., execute) the code stored in the computer-readable medium/memory 1130, including circuitry for controlling 1121 (including circuitry for operating, circuitry for ceasing, and circuitry for refraining), circuitry for determining 1122 (including circuitry for detecting, circuitry for capping, and circuitry for adjusting), circuitry for accessing 1123, circuitry for obtaining 1124, circuitry for measuring 1125, circuitry for transmitting 1126 (including circuitry for sending), circuitry for performing 1127, circuitry for using 1128, circuitry for allocating 1129, circuitry for storing 1131, and circuitry for adjusting 1132 (collectively referred to herein as circuitry 1121-1132). Processing with circuitry 1121-1132 may cause the communications device 1100 to perform the operations 1000 described with respect to FIG. 10 or any aspect related to operations described herein.

Various components of the communications device 1100 may provide means for performing the operations 1000 described with respect to FIG. 10 or any aspect related to operations described herein. For example, means for transmitting, sending or outputting for transmission may include the TX path 214 and/or antenna(s) 218 of the wireless device 102 illustrated in FIG. 2 and/or transceiver 1108 and antenna 1110 of the communications device 1100 in FIG. 11. Means for receiving or obtaining may include the RX path 216 and/or antenna(s) 218 of the wireless device 102 illustrated in FIG. 2, and/or transceiver 1108 and antenna 1110 of the communications device 1100 in FIG. 11. Means for controlling, means for measuring, means for accessing, means for allocating, means for storing, means for adjusting, means for capping, means for adjusting, means for using, means for performing, means for operating, means for ceasing, means for refraining, means for determining, means for detecting, means for monitoring, means for comparing, means for obtaining, and/or means for providing may include a processor, such as the processor 210 and/or modem 212 depicted in FIG. 2 and/or the processor(s) 1120 in FIG. 11.

### Example Aspects

Implementation examples are described in the following numbered clauses:

Clause 1: A method of wireless communication by a wireless device, comprising: determining a radio frequency (RF) exposure budget for at least one first radio associated with a radio frequency identification (RFID) radio access technology (RAT), wherein the RFID RAT is one of a plurality of RATs that the wireless device is configured to communicate with; and controlling operation of the at least one first radio associated with the RFID RAT in compliance with an RF exposure limit, based at least in part on the RF exposure budget.

Clause 2: The method of Clause 1, wherein controlling the operation of the at least one first radio associated with the RFID RAT comprises: determining a first portion of the RF exposure budget that is available to the at least one first radio for a first time interval of a time window associated with the RF exposure limit; determining at least one of a transmit power or a transmit duration for the first time interval, based on the first portion of the RF exposure budget; and sending one or more RFID transmissions during the first time interval using the at least one first radio according to the at least one of the transmit power or the transmit duration.

Clause 3: The method of Clause 2, wherein at least one of (i) the transmit power is determined further based on a distance of at least one tag from the wireless device or (ii) the transmit duration is determined further based on a number of the at least one tag to read.

Clause 4: The method according to any of Clauses 2-3, wherein the first portion of the RF exposure budget is determined based on one or more target RFID communication metrics for the time window.

Clause 5: The method of Clause 4, wherein the one or more target RFID communication metrics comprise at least one of a target tag detection rate or a target tag detection range.

Clause 6: The method according to any of Clauses 2-5, wherein the first portion of the RF exposure budget is equal to each of one or more second portions of the RF exposure budget available to the at least one first radio for one or more respective second time intervals of the time window.

Clause 7: The method according to any of Clauses 2-6, further comprising determining an unused portion of a second portion of the RF exposure budget determined for the at least one first radio for a second time interval of the time window, wherein: the second time interval is prior to the first time interval; and the first portion of the RF exposure budget is determined further based on the unused portion of the second portion of the RF exposure budget determined for the second time interval.

Clause 8: The method of Clause 7, wherein the second portion of the RF exposure budget determined for the second time interval is less than the first portion of the RF exposure budget determined for the first time interval.

Clause 9: The method according to any of Clauses 7-8, wherein determining the first portion of the RF exposure budget comprises adjusting a cap on the first portion of the RF exposure budget based on the unused portion of the second portion of the RF exposure budget determined for the second time interval.

Clause 10: The method according to any of Clauses 2-9, wherein: the plurality of RATs comprise one or more RATs different from the RFID RAT; the at least one first radio associated with the RFID RAT is active during the first time interval; and one or more second radios associated with the one or more RATs different from the RFID RAT are inactive during the first time interval.

Clause 11: The method of Clause 10, wherein the one or more RATs different from the RFID RAT comprise one or more wireless local area network (WLAN) RATs, one or more wireless wide area network (WWAN) RATS, one or more Bluetooth RATs, or any combination thereof.

Clause 12: The method according to any of Clauses 2-9, wherein: the plurality of RATs comprise at least one RAT different from the RFID RAT; the at least one first radio associated with the RFID RAT is active during the first time interval; and at least one second radio associated with the at least one RAT different from the RFID RAT is active during the first time interval.

Clause 13: The method of Clause 12, wherein the RF exposure budget is determined based at least in part on a reserve determined for each of the at least one first radio and the at least one second radio.

Clause 14: The method of Clause 13, further comprising: obtaining reserve information associated with a plurality of services allocated to a set of antenna groups, each antenna group of the set of antenna groups being associated with at least one of the at least one first radio or the at least one second radio; and determining the reserve for each of the at least one first radio and the at least one second radio, based at least in part on the reserve information, a set of services of the plurality of services mapped to each of the at least one first radio and the at least one second radio, and a respective state associated with each of the set of services.

Clause 15: The method of Clause 14, wherein: the reserve information indicates a plurality of minimum service reserves for each of the plurality of services; and each of the plurality of minimum service reserves is associated with a respective antenna group of the set of antenna groups.

Clause 16: The method of Clause 13, further comprising: obtaining reserve information associated with an antenna group associated with a plurality of radios including the at least one first radio and the at least one second radio; and determining the reserve for each of the plurality of radios based at least in part on the reserve information and an active state associated with each of the plurality of radios.

Clause 17: The method of Clause 16, wherein the reserve information includes a total reserve associated with all of the plurality of radios in the antenna group.

Clause 18: The method according to any of Clauses 16-17, wherein the reserve information includes a first reserve associated with the at least one first radio and a second reserve associated with the at least one second radio.

Clause 19: The method according to any of Clauses 16-18, wherein the reserve information includes a split ratio associated with each of the plurality of radios sharing a total reserve.

Clause 20: An apparatus comprising: one or more memories collectively storing executable instructions; and one or more processors coupled to the one or more memories, the one or more processors being collectively configured to execute the executable instructions and cause the apparatus to perform a method in accordance with any of Clauses 1-19.

Clause 21: An apparatus for wireless communications, comprising means for performing a method in accordance with any of Clauses 1-19.

Clause 22: A non-transitory computer-readable medium comprising computer-executable instructions that, when executed by one or more processors of a processing system, cause the processing system to perform a method in accordance with any of Clauses 1-19.

Clause 23: A computer program product embodied on a computer-readable storage medium comprising code for performing a method in accordance with any of Clauses 1-19.

### Additional Considerations

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, “a processor,” “at least one processor,” or “one or more processors” generally refer to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refer to a single memory configured to store data and/or instructions or multiple memories configured to collectively store data and/or instructions.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, identifying, searching, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. A hardware module may include several electrical elements (e.g., one or more dies and/or other components) packaged together.

The various illustrative logical blocks, modules and circuits described in connection with the present disclosure may be implemented or performed with a general purpose processor, a digital signal processor (DSP), a neural network processor, a system on chip (SoC), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a UE (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer-readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (random access memory), flash memory, ROM (read-only memory), PROM (programmable read-only memory), EPROM (erasable programmable read-only memory), EEPROM (electrically erasable programmable read-only memory), registers, magnetic disks, optical disks, hard drives, or any other suitable non-transitory storage medium, or any combination thereof. The machine-readable media may be embodied in a computer program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein (e.g., instructions for performing the operations described herein and illustrated in FIGS. 9-10).

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, or other physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. A method of wireless communication by a wireless device, comprising:
determining a radio frequency (RF) exposure budget for at least one first radio associated with a radio frequency identification (RFID) radio access technology (RAT), wherein the RFID RAT is one of a plurality of RATs that the wireless device is configured to communicate with; and
controlling operation of the at least one first radio associated with the RFID RAT in compliance with an RF exposure limit, based at least in part on the RF exposure budget.

2. The method of claim 1, wherein controlling the operation of the at least one first radio associated with the RFID RAT comprises:
determining a first portion of the RF exposure budget that is available to the at least one first radio for a first time interval of a time window associated with the RF exposure limit;
determining at least one of a transmit power or a transmit duration for the first time interval, based on the first portion of the RF exposure budget; and
sending one or more RFID transmissions during the first time interval using the at least one first radio according to the at least one of the transmit power or the transmit duration.

3. The method of claim 2, wherein at least one of (i) the transmit power is determined further based on a distance of at least one tag from the wireless device or (ii) the transmit duration is determined further based on a number of the at least one tag to read.

4. The method of claim 2, wherein the first portion of the RF exposure budget is determined based on one or more target RFID communication metrics for the time window.

5. The method of claim 4, wherein the one or more target RFID communication metrics comprise at least one of a target tag detection rate or a target tag detection range.

6. The method of claim 2, wherein the first portion of the RF exposure budget is equal to each of one or more second portions of the RF exposure budget available to the at least one first radio for one or more respective second time intervals of the time window.

7. The method of claim 2, further comprising determining an unused portion of a second portion of the RF exposure budget determined for the at least one first radio for a second time interval of the time window, wherein:
the second time interval is prior to the first time interval; and
the first portion of the RF exposure budget is determined further based on the unused portion of the second portion of the RF exposure budget determined for the second time interval.

8. The method of claim 7, wherein the second portion of the RF exposure budget determined for the second time interval is less than the first portion of the RF exposure budget determined for the first time interval.

9. The method of claim 7, wherein determining the first portion of the RF exposure budget comprises adjusting a cap on the first portion of the RF exposure budget based on the unused portion of the second portion of the RF exposure budget determined for the second time interval.

10. The method of claim 2, wherein:
the plurality of RATs comprise one or more RATs different from the RFID RAT;
the at least one first radio associated with the RFID RAT is active during the first time interval; and
one or more second radios associated with the one or more RATs different from the RFID RAT are inactive during the first time interval.

11. The method of claim 2, wherein:
the plurality of RATs comprise at least one RAT different from the RFID RAT;
the at least one first radio associated with the RFID RAT is active during the first time interval; and
at least one second radio associated with the at least one RAT different from the RFID RAT is active during the first time interval.

12. The method of claim 11, wherein the RF exposure budget is determined based at least in part on a reserve determined for each of the at least one first radio and the at least one second radio.

13. The method of claim 12, further comprising:
obtaining reserve information associated with a plurality of services allocated to a set of antenna groups, each antenna group of the set of antenna groups being associated with at least one of the at least one first radio or the at least one second radio; and
determining the reserve for each of the at least one first radio and the at least one second radio, based at least in part on the reserve information, a set of services of the plurality of services mapped to each of the at least one first radio and the at least one second radio, and a respective state associated with each of the set of services.

14. The method of claim 13, wherein:
the reserve information indicates a plurality of minimum service reserves for each of the plurality of services; and
each of the plurality of minimum service reserves is associated with a respective antenna group of the set of antenna groups.

15. The method of claim 12, further comprising:
obtaining reserve information associated with an antenna group associated with a plurality of radios including the at least one first radio and the at least one second radio; and
determining the reserve for each of the plurality of radios based at least in part on the reserve information and an active state associated with each of the plurality of radios.

16. The method of claim 15, wherein the reserve information includes a total reserve associated with all of the plurality of radios in the antenna group.

17. The method of claim 15, wherein the reserve information includes a first reserve associated with the at least one first radio and a second reserve associated with the at least one second radio.

18. The method of claim 15, wherein the reserve information includes a split ratio associated with each of the plurality of radios sharing a total reserve.

19. An apparatus for wireless communication, comprising:
one or more memories collectively storing executable instructions; and
one or more processors coupled to the one or more memories, the one or more processors being collectively configured to execute the executable instructions to cause the apparatus to:
determine a radio frequency (RF) exposure budget for at least one first radio associated with a radio frequency identification (RFID) radio access technology (RAT), wherein the RFID RAT is one of a plurality of RATs that the apparatus is configured to communicate with; and
control operation of the at least one first radio associated with the RFID RAT in compliance with an RF exposure limit, based at least in part on the RF exposure budget.

20. An apparatus for wireless communication, comprising:
means for determining a radio frequency (RF) exposure budget for at least one first radio associated with a radio frequency identification (RFID) radio access technology (RAT), wherein the RFID RAT is one of a plurality of RATs that the apparatus is configured to communicate with; and
means for controlling operation of the at least one first radio associated with the RFID RAT in compliance with an RF exposure limit, based at least in part on the RF exposure budget.
